(19) United States
(12) Patent Application Publication
(10) Pub. No.: US 2023/0360046 A1
(43) Pub. Date: Nov. 9, 2023

(54) BLOCKCHAIN-BASED BLOCK PROCESSING METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Gengliang ZHU, Shenzhen (CN)

(21) Appl. No.: 18/347,893

(22) Filed: Jul. 6, 2023

Related U.S. Application Data
(63) Continuation of application No. PCT/CN2022/126163, filed on Oct. 19, 2022.

(30) Foreign Application Priority Data
Nov. 30, 2021 (CN) 202111444707.8

(51) Int. Cl. G06Q 20/38; G06Q 20/40

(52) U.S. Cl. CPC G06Q 20/389; G06Q 20/401

(57) ABSTRACT

This application discloses a blockchain-based block processing method and apparatus. The method includes generating a cross-chain service block corresponding to a target service by a first consensus node of the first service branch chain for the target service that meets a cross-chain consensus condition; pre-submitting the cross-chain service block to the first service branch chain, and storing the cross-chain service block in a first cross-chain storage space; obtaining a cross-chain consensus result for the cross-chain service block from a second cross-chain storage space, wherein the cross-chain consensus result is obtained by a second consensus node in the second service branch chain obtaining the cross-chain service block from the first cross-chain storage space and performing a cross-chain consensus on the cross-chain service block; and setting a status of the cross-chain service block pre-submitted to the first service branch chain based on the cross-chain consensus result.

### RELATED APPLICATIONS

This application is a continuation of PCT/CN2022/126163, filed on Oct. 19, 2022, which in turn claims priority to Chinese Patent Application No. 202111444707.8, filed on Nov. 30, 2021, entitled “BLOCKCHAIN-BASED BLOCK PROCESSING METHOD AND APPARATUS, DEVICE, STORAGE MEDIUM, AND PROGRAM PRODUCT.” The two applications are incorporated by reference in their entirety.

### FIELD OF THE TECHNOLOGY

This application relates to the fields of computer technologies and blockchain technologies, and in particular, to a blockchain-based block processing method and block processing apparatus, a computer device, a computer-readable storage medium, and a computer program product.

### BACKGROUND OF THE DISCLOSURE

With the rapid development of blockchain technologies, more users or enterprises choose to store data in blockchain networks to prevent data from being tampered. In related technologies, different service types of data are stored in blockchain networks by using blockchains. For a multi-chain structured blockchain network, different service types of data are stored by different service types of service branch chains in the blockchain network, that is, each service branch chain corresponds to a service type, and each service branch chain processes data of a single service type corresponding to the service branch chain.

### SUMMARY

Embodiments of this application provide a blockchain-based block processing method and apparatus, a computer device, a computer-readable storage medium, and a computer program product, which may implement cross-chain consensus processing of a cross-chain service, and may also improve obtaining efficiency and storage security of cross-chain data.

An embodiment of this application provides a blockchain-based block processing method, the blockchain including a service main chain, a first service branch chain, and a second service branch chain. The method includes generating a cross-chain service block corresponding to a target service by a first consensus node of the first service branch chain for the target service that meets a cross-chain consensus condition; pre-submitting the cross-chain service block to the first service branch chain, and storing the cross-chain service block in a first cross-chain storage space corresponding to the first service branch chain; obtaining a cross-chain consensus result for the cross-chain service block from a second cross-chain storage space corresponding to the second service branch chain, wherein the cross-chain consensus result is obtained through a second consensus node in the second service branch chain obtaining the cross-chain service block from the first cross-chain storage space and performing a cross-chain consensus on the cross-chain service block; and setting a status of the cross-chain service block pre-submitted to the first service branch chain based on the cross-chain consensus result.

An embodiment of this application provides another blockchain-based block processing method, the blockchain including a service main chain, a first service branch chain, and a second service branch chain. The method includes obtaining a cross-chain service block from a first cross-chain storage space corresponding to the first service branch chain by a second consensus node in the second service branch chain, wherein the cross-chain service block is generated for a target service and stored into the first cross-chain storage space by a first consensus node in the first service branch chain in response to that the target service satisfies a cross-chain consensus condition; performing a cross-chain consensus on the cross-chain service block to obtain a cross-chain consensus result; and storing the cross-chain consensus result in a second cross-chain storage space corresponding to the second service branch chain, wherein the first consensus node obtains the cross-chain consensus result from the second cross-chain storage space based on the cross-chain consensus result and set a status of the cross-chain service block pre-submitted to the first service branch chain based on the cross-chain consensus result.

An embodiment of this application provides a computer device, including: a processor, a communication interface, and a memory, the processor, the communication interface, and the memory being connected to each other, wherein the memory stores executable program code, and the processor is configured to call the executable program code to implement the blockchain-based block processing method provided in the embodiments of this application.

An embodiment of this application further provides a non-transitory computer-readable storage medium, the computer-readable storage medium storing computer instructions, and the blockchain-based block processing method provided in the embodiments of this application being implemented when a computer device runs the computer instructions.

In embodiments of the present application, the first consensus node of the first service branch chain pre-submits the generated cross-chain service block to the first service branch chain, then the second consensus node of the second service branch chain performs a cross-chain consensus on the cross-chain service block, and finally, the first consensus node sets, based on the cross-chain consensus result, the status of the cross-chain service block pre-submitted to the first service branch chain. Accordingly, cross-chain consensus processing of a cross-chain service may be implemented. Meanwhile, different service branch chains correspond to different exclusive storage spaces, a service branch chain can store cross-chain data into its own corresponding storage space, and other service branches that need to perform processing based on the cross-chain data may directly obtain the cross-chain data from the exclusive storage space, so compared with directly obtaining the cross-chain data from the service branch chain, the efficiency is higher.

### BRIEF DESCRIPTION OF THE DRAWINGS

FIG. 1 is a schematic structural diagram of a blockchain according to an embodiment of this application.

FIG. 2 is a schematic structural diagram of a blockchain network according to an embodiment of this application.

FIG. 3 is a schematic structural diagram of a tree structure chain according to an embodiment of this application.

FIG. 4 is a schematic structural diagram of a blockchain network according to an embodiment of this application.

FIG. 5 is a schematic flowchart of a cross-chain processing procedure according to an embodiment of this application.

FIG. 6 is a schematic flowchart of a blockchain-based block processing method according to an embodiment of this application.

FIG. 7 is a schematic architecture diagram of a double-layer blockchain network according to an embodiment of this application.

FIG. 8 is a schematic architecture diagram of a double-layer blockchain network according to an embodiment of this application.

FIG. 9 is a schematic architecture diagram of a double-layer blockchain network according to an embodiment of this application.

FIG. 10 is a schematic structural diagram of a blockchain-based block processing apparatus according to an embodiment of this application.

FIG. 11 is a schematic structural diagram of a computer device according to an embodiment of this application.

### DESCRIPTION OF EMBODIMENTS

The technical solutions in embodiments of this application are clearly and completely described in the following with reference to the accompanying drawings in the embodiments of this application. Apparently, the described embodiments are merely some rather than all of the embodiments of this application. All other embodiments obtained by a person of ordinary skill in the art based on the embodiments of this application without making creative efforts shall fall within the protection scope of this application.

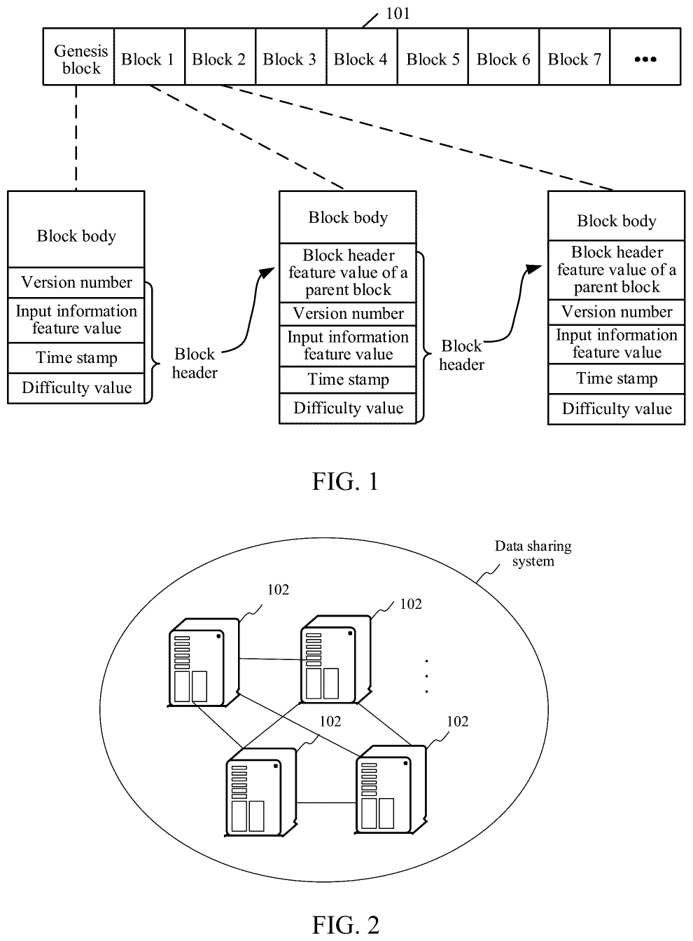

The embodiments of this application relate to a blockchain. The blockchain is the foundation of blockchain technologies. The blockchain is a novel application of computer technologies such as distributed data storage, point-to-point transmission, consensus mechanisms, and encryption algorithms. The blockchain is essentially a decentralized database, and is a series of data blocks associated by using a cryptographic method. Each data block contains information about a batch of network transactions, and is used for verifying validity of the information (anti-counterfeiting) and generating the next block. The structure of a blockchain is shown in FIG. 1. As shown in FIG. 1, the blockchain 101 includes a plurality of blocks, the first block of the blockchain is called a genesis block, the genesis block includes a block header and a block body, the block header stores an input information feature value, a version number, a time stamp, and a difficulty value, and the block body stores input information; and the next block of the genesis block regards the genesis block as a parent block and also includes a block header and a block body, and the block header stores an input information feature value of the current block, a block header feature value of the parent block, a version number, a time stamp, and a difficulty value, and so on, so that the block data stored in each block of the blockchain are associated with the block data stored in the parent block, and security of input information in the blocks is ensured.

The blockchain may be maintained by blockchain nodes contained in a blockchain network, where the blockchain network may be interpreted as a data sharing system, which refers to a system used for data sharing between blockchain nodes. A structure of the data sharing system is shown in FIG. 2. As shown in FIG. 2, the data sharing system may include a plurality of blockchain nodes 102, and each blockchain node 102 may be a server connected to the blockchain network or a user terminal (such as a client) connected to the blockchain network. The form of the blockchain nodes 102 is not limited here. Each blockchain node 102 in the blockchain network has a corresponding node identifier, and each blockchain node 102 in the blockchain network may store node identifiers of other blockchain nodes 102 in the blockchain network, to broadcast generated blocks to the other blockchain nodes 102 in the data sharing system subsequently according to the node identifiers of the other blockchain nodes 102. Each blockchain node 102 may maintain a node identifier list, and store node names and node identifiers correspondingly in the node identifier list, where the node identifier list may be seen in Table 1:

TABLE 1

| Node name | Node identifier |
|---|---|
| Node 1 | 117.114.151.174 |
| Node 2 | 117.116.189.145 |
| . . . | . . . |
| Node X (X is a positive integer) | xx.xxx.xxx.xxx |

As shown in FIG. 1, the node identifier may be an IP (Internet Protocol, which is a protocol for an interconnection between networks) address or any other type of information capable of identifying the node. For example, the node identifier may alternatively be a binary sequence code (such as 110001110), and the IP address is used as an example in Table 1 for explanation. When a to-be-verified block is generated in the blockchain network, a blockchain node running a consensus mechanism (also known as a consensus node) in the blockchain network performs a consensus on the to-be-verified block, and synchronizes the to-be-verified block to each blockchain node in the blockchain network through the node identifiers in the node identifier list after the consensus succeeds, to implement distributed storage of data in the blockchain network.

In one embodiment, the blockchain network may maintain one blockchain or a plurality of blockchains, and each blockchain may be used for storing service data corresponding to a different service type. A tax scenario is used as an example. Services involved in the tax scenario may include: an invoice service, a credit service, an import and export loss service, an enterprise qualification service, a tax refund service, and the like. To facilitate better management of service data corresponding to different service types, a blockchain may be created for each service type in the blockchain network to store corresponding service data, to manage and maintain the service data corresponding to different service types.

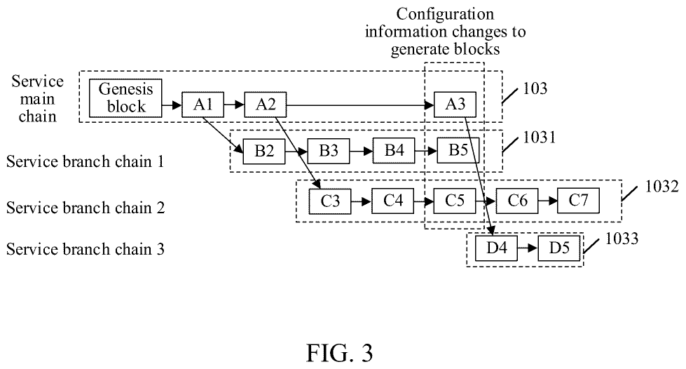

When a plurality of blockchains are maintained in the blockchain network, the blockchains usually form a tree structure chain. The tree structure chain may be simply interpreted as: a blockchain structure similar to a tree formed by a service main chain and one or more service branch chains derived from the service main chain (or referred to as bifurcation extension). A tree structure chain is shown in FIG. 3. As shown in FIG. 3, the tree structure chain includes a service main chain 103 and service branch chains derived from the service main chain 103, such as a service branch chain 1031, a service branch chain 1032, and a service branch chain 1033. The service main chain 103 and the service branch chains will be simply introduced below:
(1) The service main chain 103 may include registration information of each service branch chain, and the registration information of the service branch chain may include but is not limited to: information such as a chain identifier of the branch chain, service description information, and a node identifier of a management node. The chain identifier is a unique identifier of the service branch chain, and the service branch chain may be quickly found in the blockchain network through the chain identifier. The service description information is used for describing relevant information of a service corresponding to the service branch chain, such as the type of the service, a data format of the service, and a verification mode of the service. The node identifier of the management node refers to a node identifier of a consensus node that has permissions to manage the service branch chain (such as consensus and storage). According to different application scenarios, the registration information of the service branch chain may include other information in addition to the foregoing description. One embodiment of this application does not limit the registration information of the service branch chain.
(2) A service branch chain is derived from a block height of the service main chain, and the genesis block of the service branch chain is located in the service main chain. For example, in FIG. 3, the genesis block of the service branch chain 1031 is block A1 in the service main chain 103, the genesis block of the service branch chain 1032 is block A2 in the service main chain 103, and the genesis block of the service branch chain 1033 is block A3 in the service main chain 101. Through the bifurcation extension of service branch chains corresponding to different service types from the service main chain as described above, it may effectively ensure that the service main chain serves as a trust root of all the service branch chains, and summarizes global information such as service configuration of each branch chain, to provide convenience for subsequent management and review.

The service branch chain 1031 derived from the service main chain is used as an example below to simply describe an embodiment of the derived service branch chains. In some embodiments, when there is an event of creating (or deriving) the service branch chain 1031, a smart contract for registering service branch chains, stored in the service main chain, may be called to derive the service branch chain 1031. First, a corresponding chain identifier may be generated for the service branch chain 1031 based on the service configuration information of the to-be-created service branch chain (including service description information, a node identifier of another consensus node storing the branch chain, and the like), and the chain identifier corresponding to the service branch chain 1031 is registered and published in the service main chain; second, a genesis block “block A1” of the service branch chain 1031 is generated based on the chain identifier, the service description information, and a node identifier of a management node; and finally, the genesis block “block A1” is stored to the service main chain to derive the service branch chain 1031. After the service branch chain 1031 is successfully derived, the service branch chain 1031 may run its own transaction chaining. For example, when there is subsequently a chaining request for service data of a service type corresponding to the service branch chain 1031, a block “block B2” generated based on the service data may be chained behind the genesis block “block A1”, to achieve chaining of transaction data (or referred to as service data) corresponding to its own service type.

In the relevant content of deriving service branch chains from a service main chain described above, the following are worth explaining:
(1) If the configuration information in the blockchain network changes, the service main chain and each service branch chain in the blockchain network need to chain the changed configuration information. Only after the service main chain and all the service branch chains succeed in chaining the changed configuration information, may the service main chain and each service branch chain run their respective chaining logics, for example, the service main chain derives service branch chains, and the service branch chain chains operating data. The configuration information in the blockchain network may be different in different application scenarios. For example, in a tax scenario, the configuration information may include but is not limited to management rules, changes in computational regulations, changes in important blockchain nodes, rotation of a certificate issuance node of a chain in the tax field. One embodiment of this application does not limit the content of the configuration information in the blockchain network.

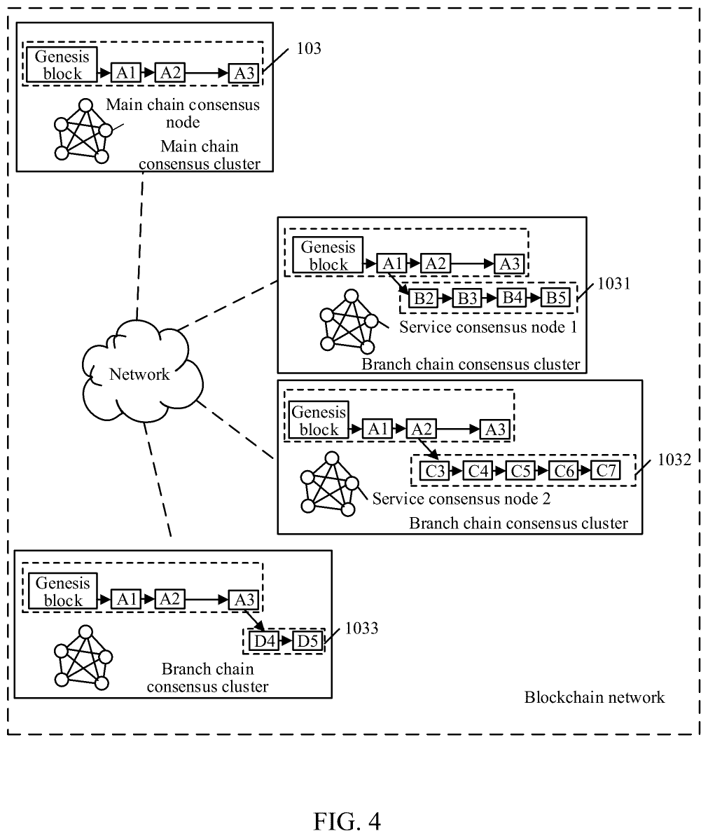

Continue to refer to FIG. 3. It is assumed that the latest block height of the current service main chain 103 is a block height corresponding to “block A2”, the latest block height of the service branch chain 1031 is a block height corresponding to “block B4”, and the latest block height of the service branch chain 1032 is a block height corresponding to “block C4”. In response to a change in the configuration information of the blockchain network, running logics of the service main chain 103 and each service branch chain (such as a deriving logic for deriving service branch chains from the service main chain, or a chaining logic for chaining the data in the service branch chain) are suspended, a new block is generated based on the changed configuration information, and the new block is synchronized to the service main chain, the service branch chain 1031, and the service branch chain 1032. For example, after the new block is synchronized to the service main chain 103, the latest block height of the service main chain 103 is updated to a block height corresponding to “block A3”, the latest block height of the service branch chain 1031 is updated to a block height corresponding to “block B5”, and the latest block height of the service branch chain 1032 is updated to a block height corresponding to “block C5”. After the service main chain and all the service branch chains succeed in generating blocks, the service main chain and each service branch chain continue to execute their respective transaction chaining. For example, the service main chain creates a new service branch chain 1033, and for example, the service branch chain 1032 adds a new “block C6”.
(2) The above mainly introduces the service main chain and the service branch chains included in the blockchain network. The following will briefly introduce nodes storing the service main chain and the service branch chains in the blockchain network with reference to FIG. 4. As shown in FIG. 4, the blockchain network may include a plurality of consensus clusters, and each consensus cluster may include one or more consensus nodes for maintaining chains in the cluster. In order to distinguish the consensus clusters that maintain the service main chain and the service branch chains, one embodiment of this application divides the consensus clusters included in the blockchain network as a whole into a main chain consensus cluster and branch chain consensus clusters. The main chain consensus cluster includes one or more main chain consensus nodes for maintaining the service main chain. Any main chain consensus node is a consensus node having management permission for the service main chain. The management permission for the service main chain may refer to: a permission to operate the service main chain and the like, for example, derive service branch chains from the service main chain. The branch chain consensus cluster includes one or more service consensus nodes for maintaining the service branch chain in the cluster. Any service consensus node is a consensus node having management permission for the service branch chain. For example, service consensus node 1 has a management permission for the service branch chain 1031, and the service consensus node 2 has a management permission for the service branch chain 1032. The management permission for the service branch chain refers to: a permission for consensus on a to-be-verified block to be stored in the service branch chain, and the like. The main chain consensus node may alternatively maintain all or some of the service branch chains, which is not limited in this embodiment. Each service consensus node maintains the service branch chain in the cluster, and also synchronizes the service main chain, but does not have a management permission for the service main chain.

The following is an introduction of the nodes storing the service main chain and the service branch chains with reference to a tax scenario. It is assumed that the tax scenario involves an invoice service and a credit service, and that a general tax bureau has management permission for all tax services. A device used by the general tax bureau in the blockchain network may access the main chain consensus cluster in the blockchain network, for example, the device used by the general tax bureau may serve as a main chain consensus node in the main chain consensus cluster. Similarly, a device used by an invoice tax bureau having a management permission for the invoice service may access an “invoice consensus cluster” among the branch chain consensus clusters, and a device used by a credit tax bureau having a management permission for the credit service may access a “credit consensus cluster” among the branch chain consensus clusters. Through the foregoing tree structure chain, services under multiple service types in the tax scenario may be stored and managed in chains, service data of different service types may be effectively distinguished, specificity of service data of each service branch chain may be maintained, management efficiency of service data may be improved, and maintenance of service data is facilitated.
(3) When a to-be-verified block is generated in any consensus cluster in the blockchain network, a consensus on the to-be-verified block may be built by a consensus node in the consensus cluster. Accordingly, different consensus clusters may perform consensuses on to-be-verified blocks in their respective clusters in parallel, thereby improving consensus efficiency. In addition, when any consensus cluster performs a consensus on a to-be-verified block generated in the cluster, the consensus cluster verifies the service branch chain included in the consensus cluster, and may also find the service main chain according to the genesis block of the service branch chain in the service main chain, and verify all blocks within a block height interval from the genesis block of the service branch chain to the genesis block of the service main chain. This improves the preciseness of block verification, and ensures the security of service data stored on the chain. In response to that all historically chained blocks in the service branch chain have been successfully verified, one embodiment of this application also supports consensus only on new to-be-verified blocks, which is hereby explained.

In one embodiment, when the tree structure chain described above is maintained in the blockchain network, there is often a demand for cross-chain processing, including: for a type of service, cross-chain consensus is required, namely, this type of service is a cross-chain service. For example, the tax scenario involves a cross-chain consensus demand for services. It is assumed that the blockchain network corresponding to the tax scenario maintains a first service branch chain corresponding to an invoice service and a second service branch chain corresponding to a credit service. It is also assumed that invoicing for a target user (for example, any user having an invoicing demand) requires a consensus (or verification) on a credit of the target user, and the invoice for the target user is valid only after the credit passes the consensus. Then, in response to an invoicing request of the target user, an invoice is first issued for the target user in the first service branch chain, where the issued invoice is invalid and cannot be used normally, and the second service branch chain needs to perform a consensus on the credit of the target user. When the second service branch chain determines that the credit of the target user has passed the consensus, the first service branch chain sets the invoice issued for the target user to be valid, and only the valid invoice can be used normally.

The foregoing process of cross-chain consensus involves cross-chain obtaining of data, including before performing the consensus on the credit of the target user, the second service branch chain needs to obtain relevant information of the target user from the first service branch chain to obtain credit data of the target user for the consensus. In addition, before setting the invoice issued for the target user to be valid, the first service branch chain needs to obtain a consensus result about the credit of the target user from the second service branch chain, and so on. To obtain data across chains, the blockchain where the cross-chain data are located may be detected, to directly obtain the required cross-chain data from the blockchain where the cross-chain data are located. However, this method is complex and inefficient, because the method requires a large amount of data interaction between blockchains and spends a lot of time for obtaining the cross-chain data.

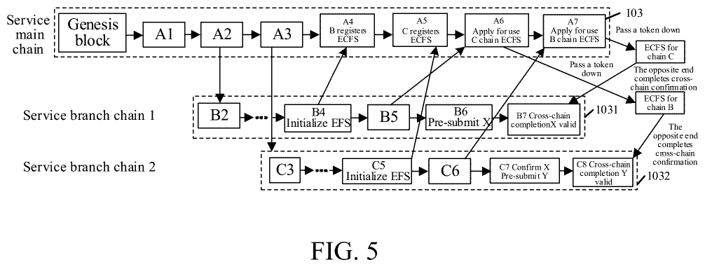

In order to implement a cross-chain consensus and improve the efficiency of obtaining cross-chain data in the cross-chain consensus, an embodiment of this application provides a block processing method based on the tree structure chain described above. A first service branch chain and a second service branch chain involved in the block processing method may refer to: two different service branch chains derived from a service main chain. Of course, the service main chain may also derive other service branch chains, that is, the blockchain may include a plurality of service branch chains, for example, three service branch chains. A process of the block processing method is shown in FIG. 5. As shown in FIG. 5,
it is assumed that the processing of a service involved in the service branch chain 1031 (namely, the first service branch chain) needs to refer to consensus results (or verification results), from the service branch chain 1032 (namely, the second service branch chain), of all or some of the features involved in the service, that is, there will be a cross-chain interaction between the service branch chain 1031 and the service branch chain 1032, where the cross-chain interaction inevitably involves a process of obtaining cross-chain data. In this case, a service consensus node, for example, a first consensus node of the service branch chain 1031 needs to request a main chain consensus node of a service main chain 103 to allocate (or register for use of) a cross-chain storage space special for storing cross-chain data involved in the service branch chain 1031. A service consensus node, for example, a second consensus node of the service branch chain 1032, also needs to request the main chain consensus node of the service main chain 103 to allocate a cross-chain storage space special for storing cross-chain data involved in the service branch chain 1032.

The service main chain 103 allocates, in response to the request of the service branch chain 1031, an exclusive cross-chain storage space B (namely, a first cross-chain storage space) to the service branch chain 1031, the exclusive cross-chain storage space B is mounted on the service consensus node of the service branch chain 1031, and the service consensus node of the service branch chain 1031 has the right to use the exclusive cross-chain storage space B for target duration (which may be set according to a requirement) or permanently; and consensus nodes of other chains need to obtain access permissions before accessing the exclusive cross-chain storage space B. The service main chain 103 allocates, in response to the request of the service branch chain 1032, an exclusive cross-chain storage space C (namely, a second cross-chain storage space) to the service branch chain 1032, the exclusive cross-chain storage space C is mounted on the service consensus node of the service branch chain 1032, the service consensus node of the service branch chain 1032 has the right to use the exclusive cross-chain storage space C for target duration (which may be set according to a requirement) or permanently, and consensus nodes of other chains need to obtain access permissions before accessing the exclusive cross-chain storage space C. The exclusive cross-chain storage spaces B and C are different.

In one embodiment, the service branch chain 1031 may request the service main chain 103 to allocate a cross-chain storage space special for storing cross-chain data involved in the service branch chain 1031, and allocation of a cross-chain storage space special for storing cross-chain data involved in the service branch chain 1032; and the service main chain 103 allocates, in response to the request of the service branch chain 1031, an exclusive cross-chain storage space B to the service branch chain 1031 and an exclusive cross-chain storage space C to the service branch chain 1032. In this case, only the service branch chain 1031 sends the request to the service main chain 103, and the service branch chain 1032 does not need to send a request to the service main chain 103, so the efficiency is higher.

The foregoing cross-chain storage space may be a cloud storage space, similar to a cloud disk. The cross-chain storage space may be represented as a mountable cross-chain detection storage component, namely (ECFS, elastic cross-chain file system).

The service branch chain 1031 and/or the service branch chain 1032 may request the cross-chain storage space from the service main chain 103 immediately after the service branch chain is initialized (or constructed), or request the cross-chain storage space from the service main chain 103 only when a cross-chain service or cross-chain processing is involved.

After the service branch chain 1031 and the service branch chain 1032 obtain the respective allocated cross-chain storage space and start respective service processing, the service branch chain 1031 and the service branch chain 1032 need to write cross-chain service related blocks in the respective chains and validity proofs of the cross-chain service blocks into the respective cross-chain storage space (ECFS) registered for use, where the cross-chain service related block may be a block generated for a service that requires a cross-chain consensus, namely, a cross-chain service, a block generated for a cross-chain consensus result of the cross-chain service, and the like; and the validity proof includes at least one of the following: indication information used for indicating validity of relevant data of the cross-chain service in the cross-chain service block, indication information used for indicating initial consensus passing of the cross-chain service block, and the like. Each service branch chain needs to maintain a height substantially consistent with the latest block height on its own chain when maintaining the cross-chain storage space, namely, needs to upload the cross-chain service related block in its own chain to its own cross-chain storage space in a timely manner. The service main chain 103 may read and spot-check each service branch chain (including service branch chains 1031 and 1032, and the like) and the cross-chain storage space of each service branch chain. By comparing, if the cross-chain storage space of the service branch chain 1031 is not validly maintained, for example, the cross-chain service related block is not uploaded to its own cross-chain storage space within a set time, or the number of times that the cross-chain service related block is not uploaded to its own cross-chain storage space exceeds a set number of times, the service main chain may reclaim the right of the service branch chain 1031 to use the cross-chain storage space B. In this case, the service branch chain 1031 and other service branch chains cannot access the cross-chain storage space B.

It is assumed that each service branch chain correctly maintains its own cross-chain storage space. Before or during a cross-chain consensus, the service branch chain 1031 applies to the service main chain 103 for an access permission to the cross-chain storage space C (the cross-chain storage space of the service branch chain 1032), and the service branch chain 1032 applies to the service main chain 103 for an access permission to the cross-chain storage space B (the cross-chain storage space of the service branch chain 1031). After successful application for the access permission, the service consensus node of the service branch chain 1031 has limited time to mount the cross-chain storage space C. After mounting the cross-chain storage space C, the service branch chain 1031 may obtain cross-chain data and a data status of the service branch chain 1032 through the cross-chain storage space C. The cross-chain storage space C is only readable for the service branch chain 1031. Similarly, after successful application for the access permission, the service consensus node of the service branch chain 1032 has limited time to mount the cross-chain storage space B. After mounting the cross-chain storage space B, the service branch chain 1032 may obtain cross-chain data and a data status of the service branch chain 1031 through the cross-chain storage space B. The cross-chain storage space B is only readable for the service branch chain 1032.

During cross-chain consensus processing, the service consensus node in the service branch chain 1031, for example, the first consensus node, generates a cross-chain service block X for a cross-chain service (namely, a target service that satisfies cross-chain consensus conditions, namely, a service that requires a cross-chain consensus), and pre-submits the cross-chain service block X to the service branch chain 1031. The pre-submitting may refer to storing the cross-chain service block on the blockchain first, but the status of the cross-chain service block is pending, namely, valid or invalid, which needs to be set later. The service consensus node in service branch chain 1031, for example, the first consensus node, may alternatively store the cross-chain service block X into the cross-chain storage space B. The service consensus node in the service branch chain 1032, for example, the second consensus node, obtains the cross-chain service block X from the cross-chain storage space B, performs a cross-chain consensus on the cross-chain service block X to obtain a cross-chain consensus result, generates a cross-chain consensus block Y based on the cross-chain consensus result, pre-submits the cross-chain consensus block Y to the service branch chain 1032, and stores the cross-chain consensus block Y into the cross-chain storage space C. Service branch chain 1031 obtains the cross-chain consensus block Y from the cross-chain storage space C, and obtains the cross-chain consensus result of the cross-chain service block X from the cross-chain consensus block Y.

If the service consensus node in the service branch chain 1031 determines, based on the cross-chain consensus result, that the cross-chain service block X has passed the cross-chain consensus of the service consensus node in the service branch chain 1032, that is, when the cross-chain consensus result represents that the cross-chain service block X has passed the cross-chain consensus, the status of the cross-chain service block X pre-submitted to the service branch chain 1031 is set to be valid.

Here, the status of the cross-chain service block X may be set to be valid in the following way: The first consensus node adds a first status declaration block behind the cross-chain service block X on the service branch chain 1031, the first status declaration block being used for declaring that the cross-chain service block X on the service branch chain 1031 is valid.

If the first consensus node determines, based on the cross-chain consensus result, that the cross-chain service block X has not passed the cross-chain consensus of the service consensus node in the service branch chain 1032, that is, when the cross-chain consensus result represents that the cross-chain service block X has not passed the cross-chain consensus, the status of the cross-chain service block X pre-submitted to the service branch chain 1031 is set to be invalid.

Here, the status of the cross-chain service block X may be set to be invalid in the following way: The first consensus node adds a second status declaration block behind the cross-chain service block X on the service branch chain 1031, the second status declaration block being used for declaring that the cross-chain service block X on the service branch chain 1031 is invalid.

In some embodiments, the service consensus node in the service branch chain 1031 alternatively stores the status declaration block of the cross-chain service block X into the cross-chain storage space B, and the service consensus node in the service branch chain 1032 obtains the status declaration block of the cross-chain service block X from the cross-chain storage space B. When the status of the cross-chain service block X declared by the status declaration block matches the cross-chain consensus result of the cross-chain service block X from the service consensus node in the service branch chain 1032, the service consensus node in the service branch chain 1032 sets the status of the cross-chain consensus block Y pre-submitted to the service branch chain 1032 to be valid, indicating that the service branch chain 1031 sets, based on the cross-chain consensus result of the cross-chain service block X from the service branch chain 1032, the status of the cross-chain service block X pre-submitted to the service branch chain 1031. Similarly, a third status declaration block may be added behind the cross-chain consensus block Y on the service branch chain 1032, the third status declaration block being used for declaring that the cross-chain consensus block Y on the service branch chain 1032 is valid.

The status of the cross-chain service block X matches the cross-chain consensus result, including: the cross-chain consensus result indicates that the cross-chain service block X has not passed the cross-chain consensus, and the status of the cross-chain service block X declared by the status declaration block is invalid; or the cross-chain consensus result indicates that the cross-chain service block X has passed the cross-chain consensus, and the status of the cross-chain service block X declared by the status declaration block is valid.

When the status of the cross-chain service block X declared by the status declaration block mismatches the cross-chain consensus result, the status of the cross-chain consensus block Y pre-submitted to the service branch chain 1032 is set to be invalid, indicating that the service branch chain 1031 does not set, based on the cross-chain consensus result of the cross-chain service block X from the service branch chain 1032, the status of the cross-chain service block X pre-submitted to the service branch chain 1031. Similarly, a fourth status declaration block may be added behind the cross-chain consensus block Y on the service branch chain 1032, the fourth status declaration block being used for declaring that the cross-chain consensus block Y on the service branch chain 1032 is invalid.

The mismatch between the status of the cross-chain service block X and the cross-chain consensus result includes: the cross-chain consensus result indicates that the cross-chain service block X has not passed the cross-chain consensus, but the status of the cross-chain service block X declared by the status declaration block is valid; or the cross-chain consensus result indicates that the cross-chain service block X has passed the cross-chain consensus, but the status of the cross-chain service block X declared by the status declaration block is invalid.

In one embodiment, the mismatch between the status of the cross-chain service block X and the cross-chain consensus result may be caused by inconsistency between the cross-chain consensus result of the cross-chain service block X obtained by the service branch chain 1031 from the service branch chain 1032 and the cross-chain consensus result of the cross-chain service block X obtained by the service branch chain 1032, where the inconsistency may be caused by malicious tampering with the cross-chain consensus result of the cross-chain service block X stored in the cross-chain storage space C. For this case, when detecting that the status of the cross-chain consensus block Y on the service branch chain 1032 is invalid, the service main chain may reset, based on the cross-chain consensus result of the cross-chain service block X from the service branch chain 1032, the status of the cross-chain service block X pre-submitted to the service branch chain 1031.

In some embodiments, the service branch chain 1032 alternatively stores the status declaration block of the cross-chain consensus block Y into the cross-chain storage space C. So far, the service branch chain 1032 completes relevant processing of the cross-chain service. If service branch chain 1031 obtains the status declaration block of the cross-chain consensus block Y from the cross-chain storage space C, it may also determine to complete relevant processing of the cross-chain service. Upon detecting the completion of the relevant processing of the cross-chain service, or upon detecting that a valid time of the access permission arrives, at least one of the following operations may be performed: the main consensus node of the service main chain revokes the access permission of the service branch chain 1031 to the cross-chain storage space C (or the service branch chain 1031 may voluntarily waive the access permission to the cross-chain storage space C, and needs to reapply an access permission for subsequent access), and the main consensus node of the service main chain revokes the access permission of the service branch chain 1032 to the cross-chain storage space B (or the service branch chain 1032 may voluntarily waive the access permission to the cross-chain storage space B, and needs to reapply an access permission for subsequent access). Before the relevant processing of the cross-chain service is completed, if the valid time of the access permission of the service branch chain 1031 to the cross-chain storage space C arrives, or the valid time of the access permission of the service branch chain 1032 to the cross-chain storage space B arrives, the service consensus node in the service branch chain 1031 or the service consensus node in the service branch chain 1032 may reapply (or renew) to the main consensus node of the service main chain 103 for an access permission to the corresponding cross-chain storage space.

For the convenience of description and understanding, the above introduces the process of cross-chain consensus using a blockchain (including a service main chain and service branch chains) as an executive subject. It may be understood that, the foregoing processing steps of the service main chain may be performed by the main chain consensus node of the service main chain, or the foregoing processing steps of the service branch chain may be performed by the service consensus node of the service branch chain.

Based on the block processing method provided by the tree structure chain, one embodiment of this application provides a mode of obtaining cross-chain data by combining a mountable cross-chain detection storage component (ECFS), in which high-speed access to cross-chain data may be implemented during the processing of a cross-chain service, so compared with directly obtaining cross-chain data from a blockchain, the data obtaining efficiency is greatly improved. This mode utilizes the characteristics of remote mounting and removal of a network storage component to implement a flexible message detection mechanism across chains, and may effectively ensure the security and permission control of the ECFS through main chain registration and allocation of the ECFS in a valid period. In addition, the emergence of the ECFS enables the service branch chain not to actively detect a target chain in the current chain when implementing cross-chain processing, thereby reducing mass redundant data. When the cross-chain processing starts, immediate mounting and immediate verification may be implemented, thereby eliminating the difficulty of synchronous verification in a height order. After the cross-chain processing is completed, the target chain data may also quickly detach from the current chain, thereby achieving secure isolation and protection of information.

Based on the cross-chain consensus solution described above, embodiments of this application provide a more detailed cross-chain consensus method. The cross-chain consensus method provided in the embodiments of this application will be introduced in detail below with reference to the accompanying drawings.

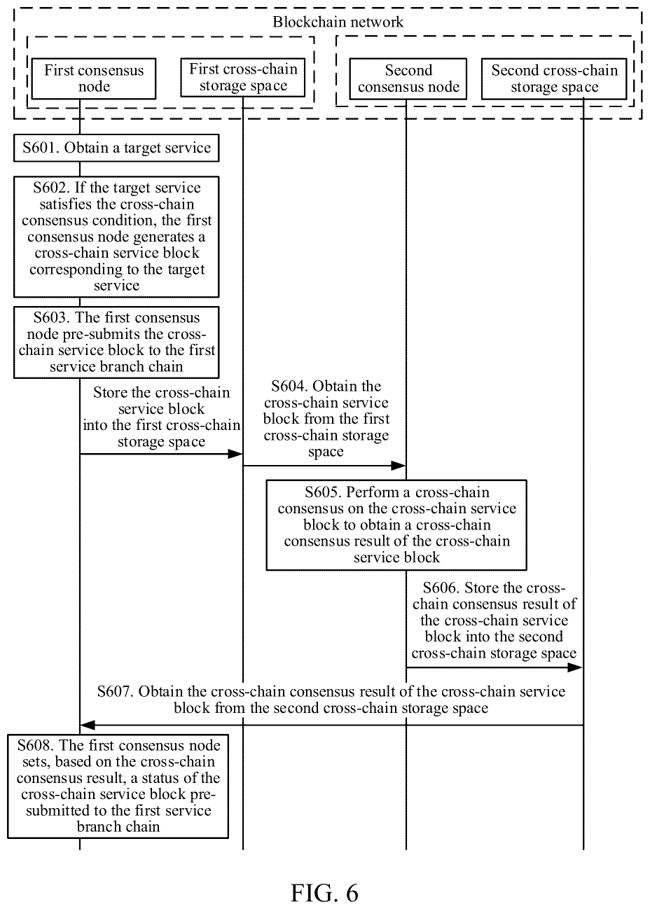

Refer to FIG. 6, which is a schematic flowchart of a blockchain-based block processing method according to an embodiment of this application. The blockchain-based block processing method may be applied to the tree structure chain described above, and may be jointly implemented by a main chain consensus node (the main chain consensus node in the main chain consensus cluster as shown in FIG. 4), a first consensus node (the service consensus node 1 as shown in FIG. 4), and a second consensus node (the service consensus node 2 as shown in FIG. 4). The main chain consensus node may be any of all consensus nodes corresponding to a service main chain (the service main chain 103 as shown in FIG. 4) in the tree structure chain; the first consensus node may be any of all service consensus nodes corresponding to a first service branch chain (the service branch chain 1031 as shown in FIG. 4) in the tree structure chain; and the second consensus node may be any of all service consensus nodes corresponding to a second service branch chain (the service branch chain 1032 as shown in FIG. 4) in the tree structure chain. The blockchain-based block processing method provided in the embodiments of this application will be described below by an example that the processing of the cross-chain service involved in the first service branch chain needs to refer to consensus results (or verification results), from the service consensus node of the second service branch chain, of all or some of the features involved in the cross-chain service. The blockchain-based block processing method includes but is not limited to the following steps:

S601. The first consensus node obtains a target service.

In one embodiment of this application, the target service may be a service that can be processed by the service consensus node of the first service branch chain, and may be interpreted as a transaction, for example, the target service may be an invoice service in a tax scenario. The first consensus node may be a master node selected by all service consensus nodes of the first service branch chain in the current stage, and the selected master node processes the target service. The master node refers to a consensus node responsible for generating a block in the current stage. The service consensus nodes of the first service branch chain except the first consensus node are slave nodes in the current stage, and the slave nodes are responsible for consensuses on the block generated by the master node in the current stage. The current stage may refer to a current block height.

After obtaining the target service, the first consensus node determines whether the target service satisfies a cross-chain consensus condition. In an embodiment, if the set consensus rule indicates that the processing of a service involved in the first service branch chain needs to refer to consensus results (or verification results), from the service consensus nodes of other service branch chains, of all or some of the features involved in the service, it is determined that the target service satisfies the cross-chain consensus condition. Alternatively, if the set consensus rule indicates that the processing, by the service consensus node of the first service branch chain, of a service of the service type of the target service needs to refer to consensus results, from the service consensus nodes of other service branch chains, of all or some of the features involved in the service of the service type, it is determined that the target service satisfies the cross-chain consensus condition. On the contrary, it is determined that the target service does not satisfy the cross-chain consensus condition.

For example, in the tax scenario, the blockchain network corresponding to the tax scenario maintains a first service branch chain corresponding to an invoice service and a second service branch chain corresponding to a credit service, and the target service is invoicing. If the invoicing requires not only consensus on the data involved in the invoice (such as invoice amount, invoice time, enterprise name, and taxpayer identification number) through the service consensus node of the first service branch chain, but also consensus on the credit of the invoicing object (such as user A) through the second service branch chain, the invoicing service is a cross-chain service and requires cross-chain consensus.

If the target service satisfies the cross-chain consensus condition, it indicates that the target service is a cross-chain service and requires cross-chain consensus processing. In this case, steps S202-S208 are performed. If the target service does not satisfy the cross-chain consensus condition, it indicates that the target service is an ordinary service and does not require cross-chain consensus processing. In this case, a to-be-chained service block is generated for the target service, and all the service consensus nodes of the first service branch chain are triggered to perform a consensus on the to-be-chained service block. When the to-be-chained service block passes the consensus, the to-be-chained service block is added to the first service branch chain.

S602. If the target service satisfies the cross-chain consensus condition, the first consensus node generates a cross-chain service block corresponding to the target service.

In one embodiment, the cross-chain service block may be the same as an ordinary block, and includes a block header and a block body, where the block header stores an input information feature value of the current block, a block header feature value of a parent block, a version number, a time stamp, and a difficulty value; and the block body stores input information, the input information being related information of the target service. In one embodiment, the cross-chain service block may have some difference from the ordinary block, the difference including one or more of the following: a cross-chain identifier is added to the cross-chain service block, the cross-chain identifier being used for indicating that the block is a cross-chain block and requires cross-chain consensus processing; and a target blockchain identifier is added to the cross-chain service block, the target blockchain identifier including an identifier of a blockchain that requires cross-chain consensus on the cross-chain service block. For example, when the blockchain that requires cross-chain consensus on the cross-chain service block includes the second service branch chain, the identifier of the second service branch chain may be determined as the target blockchain identifier.

S603. The first consensus node pre-submits the cross-chain service block to the first service branch chain, and stores the cross-chain service blocks into a first cross-chain storage space.

Here, the pre-submitting refers to adding the generated block to the blockchain first, but the status of the block is pending, that is, the block added to the blockchain may be valid or invalid, which needs to be set later. Therefore, the first consensus node pre-submits the cross-chain service block to the first service branch chain, that is, adds the cross-chain service block to the first service branch chain. The cross-chain service block may be valid or invalid, so the status used for indicating its validity needs to be set later.

The first cross-chain storage space is a cross-chain storage space special for storing cross-chain data involved in the first service branch chain, the cross-chain storage space being allocated to all service consensus nodes (including the first consensus node) of the first service branch chain by the main chain consensus node (which may be any consensus node of the service main chain or a consensus node having a cross-chain storage space allocation permission among all the consensus nodes of the service main chain) of the service main chain. The consensus nodes in other service branch chains need to obtain access permissions before accessing the first cross-chain storage space. The first cross-chain storage space may be allocated by the main chain consensus node as requested by the service consensus node of the first service branch chain immediately after the initialization (or creation) of the first service branch chain is completed, or allocated by the main chain consensus node as requested by the service consensus node of the first service branch chain when the cross-chain service is processed. The first consensus node may store the cross-chain service block into the first cross-chain storage space after pre-submitting the cross-chain service block to the first service branch chain, or store the cross-chain service block into the first cross-chain storage space while pre-submitting the cross-chain service block to the first service branch chain.

In some embodiments, there is one or more data storage blockchains in the first cross-chain storage space, and each blockchain corresponds to a service branch chain that has a cross-chain consensus relationship with the first service branch chain. The data storage blockchain may be a special blockchain, where adjacent blocks on the blockchain do not have a parent-child relationship or are independent of each other and are only added to the blockchain in chronological order. When a service consensus node of the second service branch chain is included for the cross-chain consensus on the cross-chain service block, the first consensus node may store the cross-chain service block onto a data storage blockchain corresponding to the second service branch chain in the first cross-chain storage space. In some embodiments, the first cross-chain storage space is divided into one or more sub storage spaces, each corresponding to a service branch chain that has a cross-chain consensus relationship with the first service branch chain. When a service consensus node of the second service branch chain is included for the cross-chain consensus on the cross-chain service block, the first consensus node may store the cross-chain service block into the sub storage space corresponding to the second service branch chain in the first cross-chain storage space. By using the foregoing storage method, the service consensus node of the second service branch chain may quickly obtain, from the first cross-chain storage space, the cross-chain service block (namely, cross-chain data) that needs to undergo cross-chain consensus processing.

In one embodiment, after generating the cross-chain service block, the first consensus node may trigger all the service consensus nodes of the first service branch chain to perform an initial consensus on the cross-chain service block. If the initial consensus results indicate that the cross-chain service block passes the consensus, the first consensus node pre-submits the cross-chain service block to the first service branch chain and store the cross-chain service block into the first cross-chain storage space. The initial consensus on the cross-chain service block may be a consensus on relevant information of the target service in the cross-chain service block. For example, in the tax scenario, the first service branch chain is a blockchain corresponding to the invoice service maintained in the blockchain network corresponding to the tax scenario, the target service is invoicing, and all the service consensus nodes of the first service branch chain perform an initial consensus on the cross-chain service block, where the initial consensus may be consensus on invoice related data (such as invoice amount, invoice time, enterprise name, and taxpayer identification number).

S604. The second consensus node obtains the cross-chain service block from the first cross-chain storage space.

In one embodiment of this application, the second consensus node may be any service consensus node of the second service branch chain, or a master node selected by all service consensus nodes of the second service branch chain in the current stage. The master node refers to a consensus node responsible for generating a block in the current stage. The service consensus nodes of the second service branch chain except the second consensus node are slave nodes in the current stage, and the slave nodes are responsible for consensuses on the block generated by the master node in the current stage. The current stage may refer to a current block height.

Before obtaining the cross-chain service block from the first cross-chain storage space, the second consensus node needs to obtain an access permission to the first cross-chain storage space. The second consensus node sends an access permission request for the first cross-chain storage space to the main chain consensus node of the service main chain, so that the main chain consensus node allocates, to the second consensus node, an access permission to the first cross-chain storage space in response to the access permission request. The second consensus node may immediately request, from the main chain consensus node, the access permission to the first cross-chain storage space after the main chain consensus node allocates the first cross-chain storage space to the service consensus node of the first service branch chain; or the second consensus node may request, from the main chain consensus node, the access permission to the first cross-chain storage space when involving in the processing of the cross-chain service. After obtaining the access permission to the first cross-chain storage space, the second consensus node obtains the cross-chain service block from the first cross-chain storage space. The first cross-chain storage space is only readable for the second consensus node.

In an embodiment, the first consensus node determines consensus nodes for the cross-chain consensus on the target service. If the consensus nodes for the cross-chain consensus on the target service include a service consensus node of the second service branch chain, the first consensus node broadcasts a cross-chain consensus request to the service consensus node of the second service branch chain. The cross-chain consensus request may carry a block identifier of the cross-chain service block. After the second consensus node receives the cross-chain consensus request sent by the first consensus node, if the second consensus node has currently obtained the access permission to the first cross-chain storage space, the second consensus node may immediately obtain the cross-chain service block from the first cross-chain storage space based on the block identifier, namely, may obtain the cross-chain service block from the blockchain or sub storage space corresponding to the second service branch chain in the first cross-chain storage space. If the second consensus node has currently not obtained the access permission to the first cross-chain storage space, the second consensus node sends an access permission request for the first cross-chain storage space to the main chain consensus node in response to the cross-chain consensus request, and obtains the cross-chain service block from the first cross-chain storage space based on the block identifier after obtaining an access permission, namely, may obtain the cross-chain service block from the blockchain or sub storage space corresponding to the second service branch chain in the first cross-chain storage space. In some embodiments, the cross-chain consensus request may further carry address information of the first cross-chain storage space storing the cross-chain service block.

S605. The second consensus node performs a cross-chain consensus on the cross-chain service block to obtain a cross-chain consensus result of the cross-chain service block.

In an embodiment, after obtaining the cross-chain service block, the second consensus node obtains feature data of a specific feature involved in the target service in the cross-chain service block, where the specific feature is related to the service corresponding to the second service branch chain. For example, the second service branch chain is a blockchain corresponding to the credit service maintained in the blockchain network corresponding to the tax scenario, the target service is an invoicing service, and the specific feature may be a credit of an invoicing object. A verification result of the specific feature is determined based on the feature data, the verification result being used for indicating whether the verification has passed or failed. Then, the cross-chain consensus result of the cross-chain service block may be directly determined according to the verification result. If the verification result indicates that the verification has passed, a cross-chain consensus result is generated to indicate that the cross-chain service block has passed the cross-chain consensus; or if the verification result indicates that the verification has not passed, a cross-chain consensus result is generated to indicate that the cross-chain service block has not passed the cross-chain consensus.

In another embodiment, after obtaining the cross-chain service block, the second consensus node obtains a specific feature involved in the target service in the cross-chain service block, and broadcasts the specific feature to all the service consensus nodes of the second service branch chain. All the service consensus nodes of the second service branch chain determine verification results of the specific feature based on feature data of the specific feature respectively, and return the verification results to the second consensus node. The second consensus node collects statistics on the received verification results returned by the service consensus nodes. If the verification results of the service consensus nodes exceeding a set proportion (such as ⅔) indicate that the verification has passed, a cross-chain consensus result is generated based on the statistical result to indicate that the cross-chain service block has passed the cross-chain consensus; otherwise, if the verification results of the service consensus nodes exceeding the set proportion indicate that the verification has not passed, a cross-chain consensus result is generated based on the statistical result to indicate that the cross-chain service block has not passed the cross-chain consensus.

For example, in the tax scenario, the first service branch chain is a blockchain corresponding to the invoice service maintained in the blockchain network corresponding to the tax scenario, the second service branch chain is a blockchain corresponding to the credit service maintained in the blockchain network corresponding to the tax scenario, the target service is invoicing, and the service consensus node of the first service branch chain performs an initial consensus on the cross-chain service block, where the initial consensus may be a consensus on invoice related data (such as invoice amount, invoice time, enterprise name, and taxpayer identification number). The service consensus node of the second service branch chain performs a cross-chain consensus on the cross-chain service block, where the cross-chain consensus may be a consensus on the credit of the invoicing object (such as user A). In this case, the foregoing specific feature may be the credit of the invoicing object, and the feature data of the specific feature may be historical credit data of the invoicing object. If it is determined based on the historical credit data of the invoicing object that the invoicing object has good credit and no negative (such as criminal) records, the credit of the invoicing object has passed the verification; otherwise, the credit of the invoicing object has not passed the verification.

S606. The second consensus node stores the cross-chain consensus result of the cross-chain service block into the second cross-chain storage space.

In one embodiment of this application, the second cross-chain storage space is a cross-chain storage space special for storing cross-chain data involved in the second service branch chain, the cross-chain storage space being allocated to all service consensus nodes (including the second consensus node) of the second service branch chain by the main chain consensus node (which may be any consensus node of the service main chain or a consensus node having a cross-chain storage space allocation permission among all the consensus nodes of the service main chain) of the service main chain. Consensus nodes of other chains need to obtain access permissions before accessing the second cross-chain storage space. The second cross-chain storage space may be allocated by the main chain consensus node of the service main chain as requested by the service consensus node of the second service branch chain immediately after the initialization (or creation) of the second service branch chain is completed, or allocated by the main chain consensus node of the service main chain as requested by the service consensus node of the second service branch chain when the cross-chain service is processed. Alternatively, in other embodiments, when the service consensus node of the first service branch chain requests the main chain consensus node of the service main chain to allocate the cross-chain storage space corresponding to the first service branch chain, the service consensus node of the first service branch chain also requests the main chain consensus node of the service main chain to allocate the cross-chain storage space corresponding to the second service branch chain.

In one embodiment of this application, the second consensus node may directly store the cross-chain consensus result of the cross-chain service block into the second cross-chain storage space, and the cross-chain consensus result may carry a target identifier, the target identifier being used for indicating that the cross-chain consensus result is the foregoing cross-chain consensus result of the cross-chain service block. The second consensus node may also generate a cross-chain consensus block based on the cross-chain consensus result and store the cross-chain consensus block into the second cross-chain storage space, and the cross-chain consensus block may carry a target identifier, the target identifier being used for indicating that the cross-chain consensus block carries the foregoing cross-chain consensus result of the cross-chain service block. In some embodiments, there is one or more data storage blockchains in the second cross-chain storage space, each blockchain corresponds to a service branch chain that has a cross-chain consensus relationship with the second service branch chain, and the second consensus node may store the cross-chain consensus block onto a data storage blockchain corresponding to the first service branch chain in the second cross-chain storage space. In another embodiment, the second cross-chain storage space is divided into one or more sub storage spaces, each sub storage space corresponds to a service branch chain that has a cross-chain consensus relationship with the first service branch chain, and the second consensus node may store the cross-chain consensus block or the cross-chain consensus result into the sub storage space corresponding to the first service branch chain in the second cross-chain storage space. By using the foregoing storage method, the service consensus node of the first service branch chain may quickly obtain the cross-chain consensus result of the cross-chain service block from the second cross-chain storage space.

S607. The first consensus node obtains the cross-chain consensus result of the cross-chain service block from the second cross-chain storage space.

In one embodiment of this application, the first consensus node needs to first obtain an access permission to the second cross-chain storage space before obtaining the cross-chain consensus result of the cross-chain service block from the second cross-chain storage space. The first consensus node sends an access permission request for the second cross-chain storage space to the main chain consensus node of the service main chain, so that the main chain consensus node allocates, to the first consensus node, an access permission to the second cross-chain storage space in response to the access permission request. After obtaining the access permission to the second cross-chain storage space, the first consensus node obtains the cross-chain consensus result of the cross-chain service block from the second cross-chain storage space. The second cross-chain storage space is only readable for the first consensus node.

In an embodiment, the first consensus node may immediately request, from the main chain consensus node, the access permission to the second cross-chain storage space after the main chain consensus node allocates the second cross-chain storage space to the service consensus node of the second service branch chain. The first consensus node may alternatively request, from the main chain consensus node, access permission to the second cross-chain storage space when involving in the processing of the cross-chain service. In one embodiment, the first consensus node determines consensus nodes for a cross-chain consensus on the target service. If the consensus nodes for the cross-chain consensus on the target service include a service consensus node of the second service branch chain, the first consensus node immediately requests, from the main chain consensus node, the access permission to the second cross-chain storage space.

In an embodiment, after obtaining the access permission to the second cross-chain storage space, the first consensus node may query the second cross-chain storage space at preset time intervals to obtain the cross-chain consensus result of the cross-chain service block from the second cross-chain storage space. In another embodiment, after storing the cross-chain consensus result of the cross-chain service block into the second cross-chain storage space, the second consensus node may send, to the consensus nodes of the first service branch chain (or only to the first consensus node), indication information for indicating that the cross-chain consensus result has been uploaded. After receiving the indication information and obtaining the access permission to the second cross-chain storage space, the second consensus node obtains the cross-chain consensus result of the cross-chain service block from the second cross-chain storage space. This may greatly reduce the number of times the first consensus node invalidly accesses the second cross-chain storage space, save software and hardware resources, and may also avoid access congestion caused by excessive access to the second cross-chain storage space.

In one embodiment, the first consensus node may alternatively request, from the main chain consensus node, the access permission to the second cross-chain storage space after receiving the indication information. In addition, in response to that the second consensus node stores the foregoing cross-chain consensus block into the second cross-chain storage space, the first consensus node obtains the cross-chain consensus block from the second cross-chain storage space, and extracts the cross-chain consensus result of the cross-chain service block from the cross-chain consensus block. The first consensus node may obtain the cross-chain consensus block from the data storage blockchain or sub storage space corresponding to the first service branch chain in the second cross-chain storage space.

S608. The first consensus node sets, based on the cross-chain consensus result, a status of the cross-chain service block pre-submitted to the first service branch chain.

In one embodiment of this application, if the cross-chain consensus result indicates that the cross-chain service block has passed the cross-chain consensus, the status of the cross-chain service block pre-submitted to the first service branch chain is set to be valid. In one embodiment, the first consensus node may set the status of the cross-chain service block pre-submitted to the first service branch chain to be valid in the following manner: the first consensus node adds a first status declaration block behind the cross-chain service block on the first service branch chain, the first status declaration block being used for declaring that the cross-chain service block on the first service branch chain is valid. In this case, the cross-chain service block is valid and may be used normally. If the cross-chain consensus result indicates that the cross-chain service block has not passed the cross-chain consensus, the status of the cross-chain service block pre-submitted to the first service branch chain is set to be invalid. In one embodiment, the first consensus node may set the status of the cross-chain service block pre-submitted to the first service branch chain to be invalid in the following manner: the first consensus node adds a second status declaration block behind the cross-chain service block on the first service branch chain, the second status declaration block being used for declaring that the cross-chain service block on the first service branch chain is invalid. In this case, the cross-chain service block is invalid and cannot be used normally. In one embodiment, the status of the cross-chain service block pre-submitted to the first service branch chain may be set to be invalid, and the cross-chain service block may be deleted from the first service branch chain.

In one embodiment, after generating the cross-chain consensus block based on the cross-chain consensus result, the second consensus node pre-submits the cross-chain consensus block to the second service branch chain. The pre-submitting refers to adding the generated block to the blockchain first, but the status of the block is pending, that is, the block added to the blockchain may be valid or invalid, which needs to be set later. Therefore, the second consensus node pre-submits the cross-chain consensus block to the second service branch chain, that is, adds the cross-chain consensus block to the second service branch chain. The cross-chain consensus block may be valid or invalid, so the status used for indicating its validity needs to be set later.

After completing the status setting of the cross-chain service block, the first consensus node may store the status setting result of the cross-chain service block into the first cross-chain storage space. The status setting result may include the foregoing generated status declaration block (including the first status declaration block or the second status declaration block) used for status declaration with regard to the cross-chain service block.

The second consensus node obtains the status setting result of the cross-chain service block from the first cross-chain storage space, and sets, based on the status setting result, a status of the cross-chain consensus block pre-submitted to the second service branch chain. In one embodiment, when the status of the cross-chain service block indicated by the status setting result (or declared by the status declaration block) matches the cross-chain consensus result, the status of the cross-chain consensus block pre-submitted to the second service branch chain is set to be valid, indicating that the service consensus node (or the first consensus node) of the first service branch chain sets, based on the cross-chain consensus result of the cross-chain service block from the service consensus node of the second service branch chain, the status of the cross-chain service block pre-submitted to the first service branch chain. Similarly, a third status declaration block for status declaration with regard to the cross-chain consensus block may be added behind the cross-chain consensus block on the second service branch chain, the third status declaration block being used for declaring that the cross-chain consensus block on the second service branch chain is valid.

The foregoing match between the status of the cross-chain service block indicated by the status setting result and the cross-chain consensus result includes: the cross-chain consensus result indicates that the cross-chain service block has not passed the cross-chain consensus, and the status of the cross-chain service block indicated by the status setting result is invalid; or the cross-chain consensus result indicates that the cross-chain service block has passed the cross-chain consensus, and the status of the cross-chain service block indicated by the status setting result is valid.

In one embodiment, when the status of the cross-chain service block indicated by the status setting result (or declared by the status declaration block) mismatches the cross-chain consensus result, the status of the cross-chain consensus block pre-submitted to the second service branch chain is set to be invalid, indicating that the service consensus node (or the first consensus node) of the first service branch chain does not set, based on the cross-chain consensus result of the cross-chain service block from the service consensus node of the second service branch chain, the status of the cross-chain service block pre-submitted to the first service branch chain. Similarly, a fourth status declaration block for status declaration with regard to the cross-chain consensus block may be added behind the cross-chain consensus block on the second service branch chain, the fourth status declaration block being used for declaring that the cross-chain consensus block on the second service branch chain is invalid. The foregoing mismatch between the status of the cross-chain service block indicated by the status setting result and the cross-chain consensus result includes: the cross-chain consensus result indicates that the cross-chain service block has not passed the cross-chain consensus, but the status of the cross-chain service block indicated by the status setting result is valid; or the cross-chain consensus result indicates that the cross-chain service block has passed the cross-chain consensus, but the status of the cross-chain service block indicated by the status setting result is invalid.

This situation may be caused by inconsistency between the cross-chain consensus result of the cross-chain service block obtained by the first consensus node from the service consensus node of the second service branch chain and the cross-chain consensus result of the cross-chain service block from the service consensus node of the second service branch chain, where the inconsistency may be caused by malicious tampering with the cross-chain consensus result of the cross-chain service block stored in the second cross-chain storage space. For this case, when detecting that the status of the cross-chain consensus block on the second service branch chain is invalid, the main chain consensus node of the service main chain may reset the status of the cross-chain consensus block on the first service branch chain based on the cross-chain consensus result of the cross-chain service block from the service consensus node of the second service branch chain.

In some embodiments, after completing the status setting of the cross-chain consensus block, the second consensus node may store the status setting result of the cross-chain consensus block into the second cross-chain storage space. The status setting result may include the foregoing generated status declaration block (including the third status declaration block or the fourth status declaration block) used for status declaration with regard to the cross-chain consensus block. So far, the second consensus node completes relevant processing of the cross-chain service (or the target service, or the cross-chain service block). If the first consensus node obtains the status setting result of the cross-chain consensus block from the second cross-chain storage space, the first consensus node may also determine to end the relevant processing of the cross-chain service. Upon detecting the completion of the relevant processing of the cross-chain service, or upon detecting that a valid time of the access permission arrives, at least one of the following processing may be performed: the main chain consensus node of the service main chain revokes the access permission of the service consensus node (including the first consensus node) of the first service branch chain to the second cross-chain storage space (or the service consensus node of the first service branch chain may voluntarily waive the access permission to the second cross-chain storage space, and needs to reapply an access permission for subsequent access), and the main chain consensus node of the service main chain revokes the access permission of the service consensus node (including the second consensus node) of the second service branch chain to the first cross-chain storage space (or the service consensus node of the second service branch chain may voluntarily waive the access permission to the first cross-chain storage space, and needs to reapply an access permission for subsequent access).

In one embodiment, it is detected that a first access permission revocation condition is satisfied, including at least one of the following: it is detected that the relevant processing of the cross-chain service is completed, and it is detected that the valid time of the access permission of the service consensus node (including the first consensus node) of the first service branch chain to the second cross-chain storage space arrives. The main chain consensus node of the service main chain revokes the access permission of the service consensus node (including the first consensus node) of the first service branch chain to the second cross-chain storage space, and generates a first permission revocation indication information, the first permission revocation indication information being used for indicating that the main chain consensus node has revoked the access permission of the service consensus node (including the first consensus node) of the first service branch chain to the second cross-chain storage space; and then the main chain consensus node sends the first permission revocation indication information to the service consensus node (including the first consensus node) of the first service branch chain, so that the service consensus node (including the first consensus node) of the first service branch chain learns that it has lost the access permission to the second cross-chain storage space, and needs to reapply an access permission for subsequent access to the second cross-chain storage space.

Similarly, it is detected that a second access permission revocation condition is satisfied, including at least one of the following: it is detected that the relevant processing of the cross-chain service is completed, and it is detected that the valid time of the access permission of the service consensus node (including the second consensus node) of the second service branch chain to the first cross-chain storage space arrives. The main chain consensus node of the service main chain revokes the access permission of the service consensus node (including the second consensus node) of the second service branch chain to the first cross-chain storage space, and generates a second permission revocation indication information, the second permission revocation indication information being used for indicating that the main chain consensus node has revoked the access permission of the service consensus node (including the second consensus node) of the second service branch chain to the first cross-chain storage space; and then the main chain consensus node sends the second permission revocation indication information to the service consensus node (including the second consensus node) of the second service branch chain, so that the service consensus node (including the second consensus node) of the second service branch chain learns that it has lost the access permission to the second cross-chain storage space, and needs to reapply an access permission for subsequent access to the first cross-chain storage space.

If the valid time of the access permission of the service consensus node (including the first consensus node) of the first service branch chain to the second cross-chain storage space arrives before the relevant processing of the cross-chain service is completed, the service consensus node of the first service branch chain may reapply (or apply for renewal) to the main chain consensus node of the service main chain for an access permission to the corresponding cross-chain storage space; or if the valid time of the access permission of the service consensus node (including the second consensus node) of the second service branch chain to the first cross-chain storage space arrives before the relevant processing of the cross-chain service is completed, the service consensus node of the second service branch chain may reapply (or apply for renewal) to the main chain consensus node of the service main chain for an access permission to the corresponding cross-chain storage space.

In one embodiment of this application, the first consensus node of the first service branch chain pre-submits the generated cross-chain service block to the first service branch chain, then the second consensus node of the second service branch chain performs a cross-chain consensus on the cross-chain service block, and finally, the first consensus node sets, based on the cross-chain consensus result, the status of the cross-chain service block pre-submitted to the first service branch chain. This may achieve cross-chain consensus processing of the cross-chain service. Different exclusive storage spaces special for storing cross-chain data are allocated to different service branch chains, cross-chain data involved in a service branch chain are stored into its exclusive storage space, and service consensus nodes of other service branch chains that need to perform processing based on the cross-chain data may directly obtain the cross-chain data from the exclusive storage space, so compared with directly obtaining the cross-chain data from the service branch chain, the efficiency is higher; and when the service consensus node of the service branch chain desires to obtain cross-chain data from an exclusive storage space of another service branch chain, the service consensus node needs to first obtain a permission of access to the exclusive storage space of another service branch chain, which may effectively ensure security of the stored data in the exclusive storage space of each service branch chain.

The above introduces a method that the first consensus node of the first service branch chain generates a cross-chain service block, the service consensus node of the first service branch chain may perform an initial consensus on the cross-chain service block, and then the service consensus node (including the second consensus node) of the second service branch chain performs a cross-chain consensus on the cross-chain service block. It may be understood that two or more service consensus nodes may alternatively perform the cross-chain consensus on the cross-chain service block. For example, in a tax scenario, the first service branch chain is a blockchain corresponding to an invoice service maintained in a blockchain network corresponding to the tax scenario, the second service branch chain is a blockchain corresponding to a credit service maintained in the blockchain network corresponding to the tax scenario, the third service branch chain is a blockchain corresponding to an enterprise qualification service maintained in the blockchain network corresponding to the tax scenario, the target service is invoicing, and the service consensus node of the first service branch chain performs an initial consensus on the cross-chain service block, where the initial consensus may be a consensus on invoice related data (such as invoice amount, invoice time, enterprise name, and taxpayer identification number); the service consensus node of the second service branch chain performs a cross-chain consensus on the cross-chain service block, which may be a consensus on a credit of an invoicing object (for example, company A); and the service consensus node of the third service branch chain performs a cross-chain consensus on the cross-chain service block, which may be a consensus on an enterprise qualification of the invoicing object (for example, company A). If the cross-chain consensus result of the cross-chain service block from the service consensus node of the second service branch chain and the cross-chain consensus result of the cross-chain service block from the service consensus node of the second service branch chain are both pass, the service consensus node of the first service branch chain sets the status of the cross-chain service block pre-submitted to the first service branch chain to be valid.

The embodiment of this case may refer to the foregoing cross-chain consensus described earlier, and will not be repeated here. Further, it may be understood that, for this case, two or more second service branch chains corresponding to different services may be described in the forgoing embodiment, and two or more second consensus nodes, second storage spaces, cross-chain consensus results, and the like may alternatively be described.

Further, the blockchain network may be a single-layer, double-layer, or multi-layer network, where “layer” refers to a quantity of subnetworks included in the blockchain network; the division of the subnetworks may consider a service demand, communication connections, security, and the like; and there is a consensus mechanism for mutual access between blockchain nodes in the same subnetwork to ensure security, while mutual access between blockchain nodes in different subnetworks requires at least one of the following additional operations: identity management and network control. For example, the blockchain network shown in FIG. 2 is a single-layer blockchain network, and secure access and data synchronization may be implemented between blockchain nodes in the single-layer blockchain network through a consensus mechanism. In an embodiment, the blockchain-based block processing method provided in the embodiments of this application may be applied to the single-layer blockchain network shown in FIG. 2. In this embodiment, the main chain consensus node and the service consensus nodes mentioned in the embodiments of this application are consensus nodes in the single-layer blockchain network.

In some embodiments, the blockchain-based block processing method proposed in the embodiments of this application may be applied not only to the foregoing single-layer blockchain network (for example, including only one blockchain network), but also to more complex double-layer or multi-layer blockchain networks. For example, a blockchain is applied in some scenarios, such as: bill service scenarios, and data storage scenarios for governments or commercial institutions. In these scenarios, not all nodes in the blockchain network have enough resources and necessity to become nodes participating in a blockchain consensus. However, for the sake of data security, when personal privacy or national security related data are involved in a blockchain system, this method is not applicable in universal data peer blockchain deployment manner. In order to adapt to service demands (such as internal and external networks, service networks, and office network partitions) and improve data security and confidentiality, an embodiment of this application provides a double-layer chain, which forms a “witness subnetwork-consensus subnetwork” double-layer network architecture through a peer to peer (P2P) network, where the P2P network is a peer to peer connected network, and each peer to peer connected node is called a peer node. The P2P network is based on a specific type of network protocol, so that a central node is not required between peer nodes to maintain a network status, and broadcast interaction between each node and an adjacent node maintains node statuses of the entire network and a connection status between the node and the adjacent node.

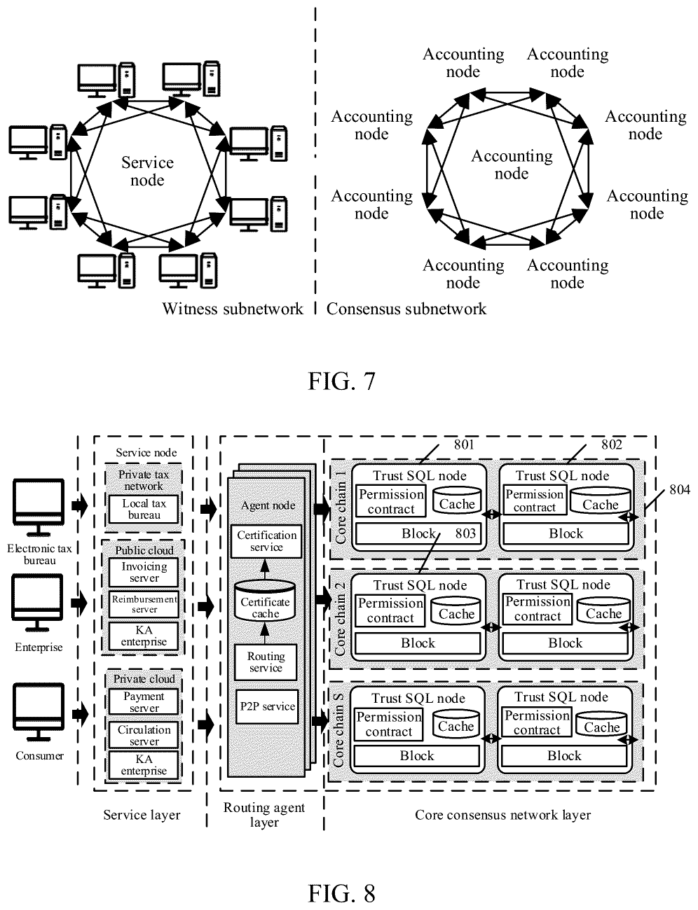

FIG. 7 shows an architecture diagram of a double-layer blockchain network according to an embodiment of this application. As shown in FIG. 7, the blockchain network includes a witness subnetwork and a consensus subnetwork. Where: (1) The witness subnetwork includes one or more service nodes, that is, service nodes are deployed in the witness subnetwork located in a public network. The service nodes in the witness subnetwork mainly perform service execution, do not participate in accounting consensus, and obtain block header data and partially authorized visible block data from the consensus subnetwork through identity authentication. (2) The consensus subnetwork is a core network in the blockchain network, and is used for accounting consensus on the blockchain network. The consensus subnetwork includes one or more consensus nodes (also referred to as accounting nodes), or the consensus subnetwork as shown in FIG. 4 above includes one or more consensus clusters, and consensus nodes running a blockchain consensus protocol, including a source consensus node and a target consensus node, are deployed in the consensus cluster. Based on this, the foregoing cross-chain consensus processing between the first service branch chain and the second service branch chain is performed in the consensus subnetwork of the double-layer network architecture. Generally, the witness subnetwork and the consensus subnetwork are located in different network environments, with the witness subnetwork in the public network and the consensus subnetwork in a private network. Because consensus subnetworks are located in relatively secure private networks, their mutual access security is inherently guaranteed by a consensus mechanism, whereby additional identity management and network control are not required. However, the service nodes in the public network may be accessed by other uncertain network terminals. Therefore, behaviors of access to the consensus subnetwork by the service nodes and other possible nodes need to be strictly controlled.

The witness subnetwork and consensus subnetwork mentioned above may interact through a routing agent network (also referred to as a routing boundary network) between the two. In some embodiments, the routing agent network is a blockchain network, and the routing agent network is used for isolating the witness subnetwork and the consensus subnetwork. The routing agent network includes one or more routing agent nodes, whereby data sent by the service nodes in the witness subnetwork may be forwarded to the consensus nodes in the consensus subnetwork through the routing agent network, and the security of data in the consensus subnetwork may be improved. In this embodiment, a more detailed architecture diagram of a double-layer blockchain network according to an embodiment of this application is shown in FIG. 8.

As shown in FIG. 8, the blockchain network includes: a service layer, a routing agent layer, and a core consensus network layer, which form an entire blockchain service system. (1) The service layer is located in a witness subnetwork, the service layer includes at least one service node, the service node may be an SPV node, the SPV node maintains a normal unstructured P2P network, and the service node may process services such as (local tax bureau) taxes, bills (enterprise invoicing), and payments (enterprise cash flow). (2) The core consensus network layer is located in a consensus subnetwork, and the core consensus network layer includes a plurality of consensus nodes with consensus functions, such as consensus node 801, consensus node 802, and consensus node 803. (3) The routing agent layer includes at least one agent node, and the agent node may provide routing services, authentication services, certificate caching services, peer to peer (P2P) services, and the like. The service layer and the core consensus network layer exchange information through the routing agent layer, that is, the service layer submits service operation interactions to the core consensus network layer through the routing agent layer, whereby the routing agent layer plays a role in isolating the service layer and the core consensus network layer.

As described in FIG. 4, the core consensus network layer (namely, the consensus subnetwork) may further include a plurality of consensus clusters. As shown in FIG. 8, the core consensus network may include a consensus cluster 804, and the consensus cluster 804 may include consensus node 801 and consensus node 802 to maintain core chain 1 within the cluster. One embodiment of this application does not limit whether the core consensus layer includes consensus nodes or consensus clusters, which is hereby explained. In addition, in this embodiment, a plurality of consensus clusters are divided into a main chain consensus cluster (or a core consensus cluster) and branch chain consensus clusters based on whether a chain maintained by the consensus cluster is a service main chain or a service branch chain. Relevant content of the main chain consensus cluster and the branch chain consensus clusters may refer to the relevant description of the embodiment shown in FIG. 4 above, and will not be repeated here.

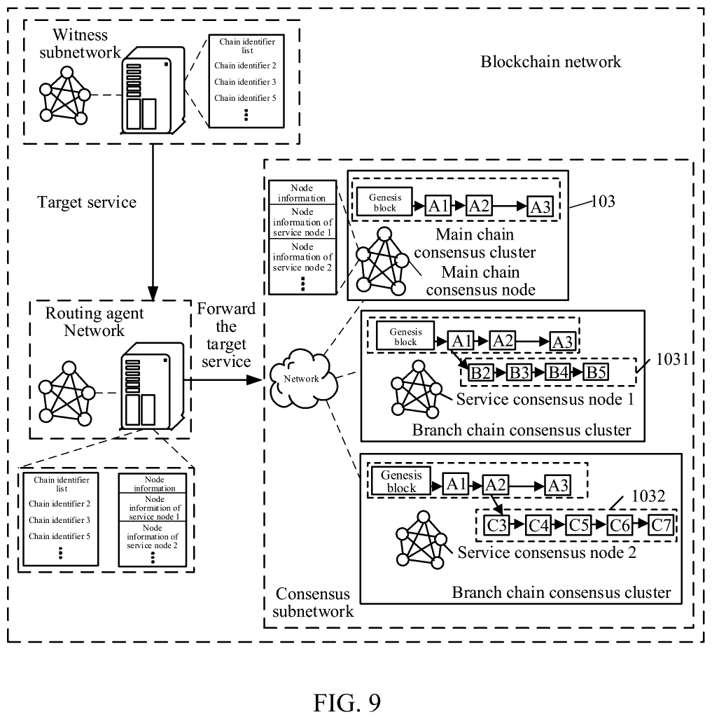

A double-layer network architecture will be introduced below with reference to FIG. 9. As shown in FIG. 9, the blockchain network includes a witness subnetwork, a routing agent network, and a consensus subnetwork. (1) Each service node (such as an SPV node) in the witness subnetwork is dynamically configured with at least one of the following chain identifiers: a chain identifier of a service main chain, and a chain identifier of one or more service branch chains. Accordingly, the service node in the witness subnetwork may participate in a service branch chain through the chain identifier (for example, access or store service data of a same service type as the service branch chain). (2) Similarly, a service main chain in the consensus subnetwork is further registered with node identifiers and addresses of the service nodes in the witness subnetwork. A service branch chain may obtain a node identifier and an address of a service node from the service main chain, and then synchronizes service data stored in the service branch chain to the service node for local storage. (3) The routing agent network records node information of each consensus node in the consensus subnetwork, and the node information may include a node identifier, a chain identifier of a stored blockchain (for example, a service main chain or a service branch chain), and the like. When a routing agent node in the routing agent network is to send service data to a service branch chain, the routing agent node may directly forward the service data to a corresponding service consensus node; otherwise, the routing agent node still forwards the service data to a main chain consensus node that maintains the service main chain, and the main chain consensus node processes the service data based on the chain identifier of each service branch chain derived from the service main chain (for example, forwards the service data to the corresponding service branch chain).

When the blockchain-based block processing method provided in the embodiments of this application is applied to the double-layer network architecture shown in FIG. 9, the service node in the witness subnetwork may send a service processing request to the routing agent node in the routing agent network, where the service processing request may include a target service to be processed; and then the routing agent node in the routing agent network determines, according to a recorded service type corresponding to each service branch chain, the service branch chain that matches the service type of the target service, and sends the target service to the service consensus node of the matching service branch chain to process the target service. The processing procedure may refer to the previous description and will not be repeated here.

In addition, the data consensus involved in the embodiments of this application may be verified by using any of the following consensus algorithms.
1) Proof-of-work (Pow) refers to a measurement method set by a system (such as the foregoing data sharing system) to achieve a goal. Simply understood, Pow is a proof used for confirming a workload. The essence is that whoever does more work has a greater chance of receiving additional rewards.
2) Proof-of-stake (Pos) is an upgraded consensus mechanism of Pow. In some embodiments, whoever holds electronic resources for a longer time (a time length of holding electronic resources=a quantity of held electronic resources * time of holding electronic resources) has a greater chance of obtaining accounting rights for blocks, where the electronic resources may refer to resources that are stored in an electronic account in an electronic form and can be circulated through the Internet. According to the proportion and time of electronic resources occupied by each node, a mining difficulty may be reduced proportionally, thereby accelerating finding of a random number. Pos shortens the time for reaching a consensus to some extent, but still requires mining.
3) Delegated proof of stake (DPos) is similar to board voting, where holders of electronic resources vote a quantity of nodes to represent them for verification and accounting. In order to motivate more people to participate in the election, the system generates a small quantity of electronic resources as rewards. The DPos mechanism allows each holder of Bitshares to vote, resulting in 101 representatives, which may be interpreted as 101 super nodes or mining pools, where these 101 super nodes have completely equal rights to each other. If the selected representatives cannot fulfill their responsibilities (they are unable to generate blocks in their turn), these representatives will be removed, and the network will select new super nodes to replace them. This enables the DPos mechanism to greatly reduce the quantity of verification and accounting nodes and to achieve second-level consensus verification, but the entire consensus mechanism still relies on electronic resources.
4) Practical Byzantine fault tolerance (pbft) is a message passing based consensus algorithm that goes through three stages to reach a consensus, where the stages may be repeated due to failures. In some embodiments, it is assumed that a total number of nodes is 3f+1, where f is a Byzantine error node. First, when a node discovers that a leader (such as a representative node, accounting node, or super node) does wrong, another replicate (node) is elected as a leader through the algorithm. Second, the leader broadcasts a value selected by the leader to another replica node through a pre-prepare message, and another replica node sends a prepare message if acceptance or does not send a prepare message if not acceptance. Next, once 2f nodes accept the prepare message, the nodes send commit messages. Finally, after 2f+1 nodes accept the commit messages, it represents that the value is determined. The foregoing process enables the pbft to reach a consensus that each node includes a service participant or manager, and security and stability are guaranteed by the service related part. Moreover, the delay of consensus is approximately 2-5 seconds, which basically meets the requirements of commercial real-time processing, so consensus efficiency is improved and a demand for a high-frequency transaction volume may be met.
5) Paxos (a distributed algorithm) algorithm is a two-stage algorithm, mainly including three types of roles: a proposer, an acceptor, and a learner. The proposer proposes a proposal, the acceptor consents or rejects the proposal, and the learner obtains a final value after a consensus is reached. The Paxos algorithm includes two stages, respectively: (1) Preparation stage: The proposer selects a proposal number n and sends a prepare request to a majority of acceptors. After an acceptor receives the prepare request, if the proposal number is greater than the number of all prepare requests it has already replied to, the acceptor replies to the proposer with the last accepted proposal and promises not to reply to proposals smaller than n. (2) Approval stage: After a proposer receives replies to the prepare request from the majority of acceptors, the proposer enters the approval stage; the proposer needs to send an accept request to the acceptors that reply to the prepare request, including the number n and a value (if there are no accepted values, the proposer may freely determine the value); and the acceptor accepts and receives the accept request without violating its promises to other proposers.
6) Raft (a distributed consensus algorithm) algorithm includes three roles: a follower, a candidate, and a leader. A node may only be one of the three statuses at a time, and the three roles may switch to each other over time and under changing conditions. All nodes have an initial status of follower. The follower that has not received any heartbeat packet over time will become a candidate and broadcast a voting request. The node that obtains the most votes will become a leader. This round of voting process is who is the first to vote and who benefited, and each node will only give one vote. The leader node periodically sends heartbeat packets to other nodes, and the failure of the leader node will trigger a new round of voting process.

This embodiment does not limit which one or more consensus algorithms are used, which is hereby explained.

Moreover, the executive subject used for executing each step in the foregoing method embodiment may be composed of hardware, software, or a combination of software and hardware. In addition, in the embodiments of this application, the relevant data such as the target service, the invoice related data, the invoicing object, feature data, and credit data are authorized by the user. When the foregoing embodiments of this application are applied to products or technologies, the data involved in use need to obtain user permission or consent, and the collection, use, and processing of the relevant data need to comply with relevant laws, regulations, and standards of relevant countries and regions.

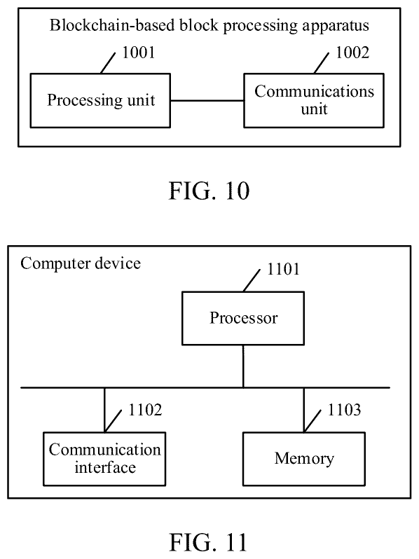

Refer to FIG. 10, which is a schematic structural diagram of a blockchain-based block processing apparatus according to an embodiment of this application. The blockchain includes a service main chain, a first service branch chain, and a second service branch chain. In one embodiment, the blockchain-based block processing apparatus described in the embodiments of this application may correspond to the foregoing first consensus node, and the apparatus includes:
a processing unit 1001, configured to generate, for a target service that satisfies a cross-chain consensus condition, a cross-chain service block corresponding to the target service;
the processing unit 1001, further configured to pre-submit the cross-chain service block to the first service branch chain;
a communication unit 1002, configured to store the cross-chain service block into a first cross-chain storage space corresponding to the first service branch chain;
the communication unit 1002, further configured to obtain a cross-chain consensus result for the cross-chain service block from a second cross-chain storage space corresponding to the second service branch chain, where.
the cross-chain consensus result is obtained in a manner that a second consensus node in the second service branch chain obtains the cross-chain service block from the first cross-chain storage space and performs a cross-chain consensus on the cross-chain service block; and
processing unit 1001, further configured to set, based on the cross-chain consensus result, a status of the cross-chain service block pre-submitted to the first service branch chain.

In an embodiment, the processing unit 1001 is further configured to:
set the status of the cross-chain service block pre-submitted to the first service branch chain to be valid when the cross-chain consensus result represents that the cross-chain service block has passed the cross-chain consensus; or set the status of the cross-chain service block pre-submitted to the first service branch chain to be invalid when the cross-chain consensus result represents that the cross-chain service block has not passed the cross-chain consensus.

In an embodiment, the processing unit 1001 is further configured to determine consensus nodes for a cross-chain consensus on the target service; and the communication unit 1002 is further configured to obtain the cross-chain consensus result for the cross-chain service block from the second cross-chain storage space corresponding to the second service branch chain, if the consensus nodes for the cross-chain consensus on the target service include the second consensus node.

In an embodiment, the communication unit 1002 is further configured to send a cross-chain consensus request to the second consensus node, where the cross-chain consensus request carries a block identifier of the cross-chain service block; and
the cross-chain consensus request is used for requesting the second consensus node to obtain the cross-chain service block from the first cross-chain storage space based on the block identifier, and to perform the cross-chain consensus on the cross-chain service block.

In an embodiment, the processing unit 1001 is further configured to perform an initial consensus on the cross-chain service block to obtain an initial consensus result; and
if the initial consensus result indicates that the cross-chain service block has passed the consensus, the cross-chain service block is pre-submitted to the first service branch chain, and the communication unit 1002 is triggered to store the cross-chain service block into the first cross-chain storage space corresponding to the first service branch chain.

In an embodiment, a main chain consensus node of the service main chain allocates an access permission to the second cross-chain storage space to the first consensus node of the first service branch chain, and allocates an access permission to the first cross-chain storage space to the second consensus node of the second service branch chain; and
the communication unit 1002 is further configured to receive a permission revocation indication information sent by the main chain consensus node, where the permission revocation indication information is used for indicating that the main chain consensus node has revoked the access permission of the first consensus node to the second cross-chain storage space; and the permission revocation indication information is generated by the main chain consensus node upon detecting that an access permission revocation condition is satisfied, and the access permission revocation condition includes at least one of the following: a valid time of the access permission arrives, and relevant processing of the cross-chain service block is completed.

In other feasible embodiments, the blockchain-based block processing apparatus described in the embodiments of this application may correspond to the foregoing second consensus node, and the apparatus includes:
a communication unit 1002, configured to obtain a cross-chain service block from a first cross-chain storage space corresponding to the first service branch chain, where the cross-chain service block is generated for a target service and stored into the first cross-chain storage space by a first consensus node in the first service branch chain when the target service satisfies a cross-chain consensus condition;
a processing unit 1001, configured to perform a cross-chain consensus on the cross-chain service block to obtain a cross-chain consensus result; and
the communication unit 1002, further configured to store the cross-chain consensus result into a second cross-chain storage space, where the cross-chain consensus result is used for the first consensus node to obtain the cross-chain consensus result from the second cross-chain storage space and set, based on the cross-chain consensus result, a status of the cross-chain service block pre-submitted to the first service branch chain.

In an embodiment, the processing unit 1001 is further configured to generate a cross-chain consensus block based on the cross-chain consensus result, and pre-submit the cross-chain consensus block to the second service branch chain;
the communication unit 1002 is further configured to obtain, from the first cross-chain storage space, a status setting result stored by the first consensus node for the cross-chain service block; and
processing unit 1001 is further configured to set, based on the status setting result, a status of the cross-chain consensus block pre-submitted to the second service branch chain.

In an embodiment, the communication unit 1002 is further configured to: store the cross-chain consensus block into the second cross-chain storage space, where the cross-chain consensus block is used for the first consensus node to obtain the cross-chain consensus block from the second cross-chain storage space and extract the cross-chain consensus result from the cross-chain consensus block.

In an embodiment, the communication unit 1002 is further configured to:
receive a cross-chain consensus request sent by the first consensus node, where the cross-chain consensus request carries a block identifier of the cross-chain service block; and obtain the cross-chain service block from the first cross-chain storage space based on the block identifier in response to the cross-chain consensus request.

In an embodiment, a main chain consensus node of the service main chain allocates an access permission to the second cross-chain storage space to the first consensus node of the first service branch chain, and allocates an access permission to the first cross-chain storage space to the second consensus node of the second service branch chain;
the communications unit 1002 is further configured to: receive a permission revocation indication information sent by the main chain consensus node, where the permission revocation indication information is used for indicating that the main chain consensus node has revoked the access permission of the second consensus node to the first cross-chain storage space; and
the permission revocation indication information is generated by the main chain consensus node upon detecting that an access permission revocation condition is satisfied, and the access permission revocation condition includes at least one of the following: a valid time of the access permission arrives, and relevant processing of the cross-chain service block is completed.

It may be understood that, a function of each functional unit of the blockchain-based block processing apparatus provided in the embodiments of this application may be implemented according to the relevant method in the foregoing method embodiment, and the embodiment process may refer to related descriptions in the foregoing method embodiment and will not be repeated here.

In one embodiment, the blockchain-based block processing apparatus provided in the embodiments of this application may be implemented by software. The blockchain-based block processing apparatus may be stored in a memory, which may be software in a form of a program and a plug-in and includes a series of units, including a processing unit and a communication unit, where the processing unit and the communication unit are configured to implement the blockchain-based block processing method provided in the embodiments of this application.

In other embodiments, the blockchain-based block processing apparatus provided in the embodiments of this application may alternatively be implemented in a combination of hardware and software. For example, the blockchain-based block processing apparatus provided in the embodiments of this application may use a processor in a hardware decoding processor form, which is programmed to perform the block processing method provided in the embodiments of this application. For example, the processor in the hardware decoding processor form may use one or more application specific integrated circuits (ASICs), a digital signal processor (DSP), a programmable logic device (PLD), a complex programmable logic device (CPLD), a field-programmable gate array (FPGA), or other electronic elements.

In one embodiment of this application, the first consensus node of the first service branch chain pre-submits the generated cross-chain service block to the first service branch chain, then the second consensus node of the second service branch chain performs a cross-chain consensus on the cross-chain service block, and finally, the first consensus node sets, based on the cross-chain consensus result, the status of the cross-chain service block pre-submitted to the first service branch chain. This may achieve cross-chain consensus processing of the cross-chain service. Different exclusive storage spaces special for storing cross-chain data are allocated to different service branch chains, cross-chain data involved in a service branch chain are stored into its exclusive storage space, and service consensus nodes of other service branch chains that need to perform processing based on the cross-chain data may directly obtain the cross-chain data from the exclusive storage space, so compared with directly obtaining the cross-chain data from the service branch chain, the efficiency is higher; and when the service consensus node of the service branch chain desires to obtain cross-chain data from an exclusive storage space of another service branch chain, the service consensus node needs to first obtain a permission of access to the exclusive storage space of another service branch chain, which may effectively ensure security of the stored data in the exclusive storage space of each service branch chain.

Refer to FIG. 11, which is a schematic structural diagram of a computer device according to an embodiment of this application. The computer device described in this embodiment includes: a processor 1101, a communication interface 1102, and a memory 1103. The processor 1101, the communication interface 1102, and the memory 1103 may be connected through a bus or in another manner. Connection through a bus is used as an example in this embodiment of the present disclosure.

The processor 1101 (or referred to as a central processing unit (CPU)) is a computing core and control core of the computer device. The processor may parse various instructions in the computer device and process various data of the computer device. For example, the CPU may be configured to parse on/off instructions sent by a user to the computer device and control the computer device to perform on/off operations. For another example, the CPU may transmit various types of interactive data between internal structures of the computer device, and the like. The communication interface 1102 may include a standard wired interface and a standard wireless interface (such as Wi-Fi and a mobile communication interface), and is controlled by the processor 1101 to transmit and receive data. Memory 1103 is a memory device in a computer device, and is configured to store a program and data. It may be understood that memory 1103 here may include an internal memory of the computer device, and may also include an expanded memory supported by the computer device. The memory 1103 provides a storage space, the storage space stores an operating system of the computer device, and the operating system may include but is not limited to: an Android system, an iOS system, a Windows Phone system, and the like, which are not limited by this application.

In this embodiment, the computer device is configured to implement the blockchain-based block processing method in the foregoing embodiment, where the blockchain includes a service main chain, a first service branch chain, and a second service branch chain; the first service branch chain corresponds to a first cross-chain storage space, and the second service branch chain corresponds to a second cross-chain storage space; and a main chain consensus node of the service main chain allocates an access permission to the second cross-chain storage space to a first consensus node of the first service branch chain, and allocates an access permission to the first cross-chain storage space to a second consensus node of the second service branch chain.

In one embodiment, the computer device may correspond to the foregoing first consensus node. In this case, processor 1101 performs the blockchain-based block processing method provided in the embodiments of this application by running executable program code in the memory 1104.

In this embodiment, the first consensus node of the first service branch chain pre-submits a generated cross-chain service block to the first service branch chain, then the second consensus node of the second service branch chain performs a cross-chain consensus on the cross-chain service block, and finally, the first consensus node sets, based on a cross-chain consensus result, a status of the cross-chain service block pre-submitted to the first service branch chain. Accordingly, cross-chain consensus processing of a cross-chain service may be implemented. Meanwhile, different service branch chains correspond to different exclusive storage spaces, a service branch chain can store cross-chain data into its own corresponding exclusive storage space, and other service branches that need to perform processing based on the cross-chain data may directly obtain the cross-chain data from the exclusive storage space, so compared with directly obtaining the cross-chain data from the service branch chain, the efficiency is higher.

An embodiment of this application further provides a computer-readable storage medium, the computer-readable storage medium storing a computer program that, when run on a computer, causes the computer to implement the blockchain-based block processing method described in the embodiments of this application.

An embodiment of this application further provides a computer program product, the computer program product including a computer program or computer instructions, and the blockchain-based block processing method provided in the embodiments of this application being implemented when the computer program or computer instructions are executed by a processor.

An embodiment of this application further provides a computer program, the computer program including computer instructions stored in a computer-readable storage medium, a processor of the computer device reading the computer instructions from the computer-readable storage medium, the processor executing the computer instructions, and the computer device being enabled to perform the blockchain-based block processing method provided in the embodiments of this application.

To simplify the description, the foregoing method embodiments are described as a series of action combinations. But persons of ordinary skill in the art would know that this application is not limited to any described sequence of actions, as some steps may adopt other sequences or may be executed simultaneously according to this application. In addition, a person skilled in the art would also know that all the embodiments described in the specification are examples, and the involved actions and modules are not necessarily mandatory according to this application.

A person of ordinary skill in the art may understand that all or some steps in the methods in the foregoing embodiments may be performed by a program instructing related hardware. The program may be stored in a computer-readable storage medium. The storage medium may include: a flash drive, a read-only memory (ROM), a random access memory (RAM), a magnetic disk, an optical disc, and the like.

Disclosed above are merely some embodiments of this application, and the scope of protection of this application cannot be limited thereto. Therefore, equivalent variations made in accordance with the claims of this application fall within the scope of this application.

What is claimed is:

1. A blockchain-based block processing method, the method being performed by a computer device, the blockchain comprising a service main chain, a first service branch chain, and a second service branch chain, and the method comprises:
generating a cross-chain service block corresponding to a target service by a first consensus node of the first service branch chain for the target service that meets a cross-chain consensus condition;
pre-submitting the cross-chain service block to the first service branch chain, and storing the cross-chain service block in a first cross-chain storage space corresponding to the first service branch chain;
obtaining a cross-chain consensus result for the cross-chain service block from a second cross-chain storage space corresponding to the second service branch chain, wherein
the cross-chain consensus result is obtained through a second consensus node in the second service branch chain obtaining the cross-chain service block from the first cross-chain storage space and performing a cross-chain consensus on the cross-chain service block; and
setting a status of the cross-chain service block pre-submitted to the first service branch chain based on the cross-chain consensus result.

2. The method according to claim 1, wherein the setting a status of the cross-chain service block pre-submitted to the first service branch chain based on the cross-chain consensus result, comprises:
setting the status of the cross-chain service block pre-submitted to the first service branch chain to be valid in response to that the cross-chain consensus result indicates that the cross-chain service block has passed the cross-chain consensus; or
setting the status of the cross-chain service block pre-submitted to the first service branch chain to be invalid in response to that the cross-chain consensus result indicates that the cross-chain service block has not passed the cross-chain consensus.

3. The method according to claim 1, wherein the method further comprises:
determining consensus nodes for a cross-chain consensus on the target service; and
in response to that the consensus nodes for the cross-chain consensus on the target service comprise the second consensus node, performing the step of obtaining a cross-chain consensus result for the cross-chain service block from a second cross-chain storage space corresponding to the second service branch chain.

4. The method according to claim 3, wherein the method further comprises:
sending a cross-chain consensus request to the second consensus node, wherein the cross-chain consensus request carries a block identifier of the cross-chain service block; and
the cross-chain consensus request requests the second consensus node to obtain the cross-chain service block from the first cross-chain storage space based on the block identifier, and to perform the cross-chain consensus on the cross-chain service block.

5. The method according to claim 1, wherein the method further comprises:
performing an initial consensus on the cross-chain service block to obtain an initial consensus result; and
in response to that the initial consensus result indicates that the cross-chain service block has passed the consensus, performing the step of pre-submitting the cross-chain service block to the first service branch chain, and storing the cross-chain service block in a first cross-chain storage space corresponding to the first service branch chain.

6. The method according to claim 1, wherein a main chain consensus node of the service main chain allocates an access permission to the second cross-chain storage space to the first consensus node of the first service branch chain, and allocates an access permission to the first cross-chain storage space to the second consensus node of the second service branch chain, and the method further comprises:
receiving a permission revocation indication information sent by the main chain consensus node, wherein the permission revocation indication information indicating that the main chain consensus node has revoked the access permission of the first consensus node to the second cross-chain storage space; and
the permission revocation indication information is generated by the main chain consensus node upon detecting that an access permission revocation condition is satisfied, and the access permission revocation condition comprises at least one of the following: the access permission time expiring, and relevant processing of the cross-chain service block being completed.

7. The method according to claim 2, wherein the method further comprises:
performing an initial consensus on the cross-chain service block to obtain an initial consensus result; and
in response to that the initial consensus result indicates that the cross-chain service block has passed the consensus, performing the step of pre-submitting the cross-chain service block to the first service branch chain, and storing the cross-chain service block in a first cross-chain storage space corresponding to the first service branch chain.

8. The method according to claim 3, wherein a main chain consensus node of the service main chain allocates an access permission to the second cross-chain storage space to the first consensus node of the first service branch chain, and allocates an access permission to the first cross-chain storage space to the second consensus node of the second service branch chain, and the method further comprises:
receiving a permission revocation indication information sent by the main chain consensus node, wherein the permission revocation indication information indicating that the main chain consensus node has revoked the access permission of the first consensus node to the second cross-chain storage space; and
the permission revocation indication information is generated by the main chain consensus node upon detecting that an access permission revocation condition is satisfied, and the access permission revocation condition comprises at least one of the following: the access permission time expiring, and relevant processing of the cross-chain service block being completed.

9. A blockchain-based block processing method, the blockchain comprising a service main chain, a first service branch chain, and a second service branch chain, and the method comprising:
obtaining a cross-chain service block from a first cross-chain storage space corresponding to the first service branch chain by a second consensus node in the second service branch chain, wherein the cross-chain service block is generated for a target service and stored into the first cross-chain storage space by a first consensus node in the first service branch chain in response to that the target service satisfies a cross-chain consensus condition;
performing a cross-chain consensus on the cross-chain service block to obtain a cross-chain consensus result; and
storing the cross-chain consensus result in a second cross-chain storage space corresponding to the second service branch chain, wherein
the first consensus node obtains the cross-chain consensus result from the second cross-chain storage space based on the cross-chain consensus result and set a status of the cross-chain service block pre-submitted to the first service branch chain based on the cross-chain consensus result.

10. The method according to claim 9, wherein the method further comprises:
generating a cross-chain consensus block based on the cross-chain consensus result, and pre-submitting the cross-chain consensus block to the second service branch chain;
obtaining a status setting result stored by the first consensus node for the cross-chain service block from the first cross-chain storage space; and
setting a status of the cross-chain consensus block pre-submitted to the second service branch chain based on the status setting result.

11. The method according to claim 10, wherein the storing the cross-chain consensus result into a second cross-chain storage space corresponding to the second service branch chain comprises:
storing the cross-chain consensus block into the second cross-chain storage space, wherein
the first consensus node obtains the cross-chain consensus block from the second cross-chain storage space based on the cross-chain consensus block and extracts the cross-chain consensus result from the cross-chain consensus block.

12. The method according to claim 9, wherein the obtaining a cross-chain service block comprises:
receiving a cross-chain consensus request sent by the first consensus node, wherein the cross-chain consensus request carries a block identifier of the cross-chain service block; and
obtaining the cross-chain service block from the first cross-chain storage space based on the block identifier in response to the cross-chain consensus request.

13. The method according to claim 9, wherein a main chain consensus node of the service main chain allocates an access permission to the second cross-chain storage space to the first consensus node of the first service branch chain, and allocates an access permission to the first cross-chain storage space to the second consensus node of the second service branch chain, and the method further comprises:
receiving a permission revocation indication information sent by the main chain consensus node, wherein the permission revocation indication information indicating that the main chain consensus node has revoked the access permission of the second consensus node to the first cross-chain storage space; and
the permission revocation indication information is generated by the main chain consensus node upon detecting that an access permission revocation condition is satisfied, and the access permission revocation condition comprises at least one of the following: time of the access permission expiring, and relevant processing of the cross-chain service block being completed.

14. The method according to claim 10, wherein the obtaining a cross-chain service block comprises:
receiving a cross-chain consensus request sent by the first consensus node, wherein the cross-chain consensus request carries a block identifier of the cross-chain service block; and
obtaining the cross-chain service block from the first cross-chain storage space based on the block identifier in response to the cross-chain consensus request.

15. A computer device, the computer device comprising: a processor, a communication interface, and a memory, the processor, the communication interface, and the memory being connected to each other, wherein.
the memory stores executable program code, and the processor is configured to call the executable program code to implement a blockchain-based block processing method, the method being performed by a computer device, the blockchain comprising a service main chain, a first service branch chain, and a second service branch chain, and the method comprises:
generating a cross-chain service block corresponding to a target service by a first consensus node of the first service branch chain for the target service that meets a cross-chain consensus condition;
pre-submitting the cross-chain service block to the first service branch chain, and storing the cross-chain service block in a first cross-chain storage space corresponding to the first service branch chain;
obtaining a cross-chain consensus result for the cross-chain service block from a second cross-chain storage space corresponding to the second service branch chain, wherein
the cross-chain consensus result is obtained through a second consensus node in the second service branch chain obtaining the cross-chain service block from the first cross-chain storage space and performing a cross-chain consensus on the cross-chain service block; and
setting a status of the cross-chain service block pre-submitted to the first service branch chain based on the cross-chain consensus result.

16. The computer device according to claim 15, wherein the setting a status of the cross-chain service block pre-submitted to the first service branch chain based on the cross-chain consensus result, comprises:
setting the status of the cross-chain service block pre-submitted to the first service branch chain to be valid in response to that the cross-chain consensus result indicates that the cross-chain service block has passed the cross-chain consensus; or
setting the status of the cross-chain service block pre-submitted to the first service branch chain to be invalid in response to that the cross-chain consensus result indicates that the cross-chain service block has not passed the cross-chain consensus.

17. The computer device according to claim 15, wherein the method further comprises:
determining consensus nodes for a cross-chain consensus on the target service; and
in response to that the consensus nodes for the cross-chain consensus on the target service comprise the second consensus node, performing the step of obtaining a cross-chain consensus result for the cross-chain service block from a second cross-chain storage space corresponding to the second service branch chain.

18. The computer device according to claim 17, wherein the method further comprises:
sending a cross-chain consensus request to the second consensus node, wherein the cross-chain consensus request carries a block identifier of the cross-chain service block; and
the cross-chain consensus request requests the second consensus node to obtain the cross-chain service block from the first cross-chain storage space based on the block identifier, and to perform the cross-chain consensus on the cross-chain service block.

19. The computer device according to claim 15, wherein the method further comprises:
performing an initial consensus on the cross-chain service block to obtain an initial consensus result; and
in response to that the initial consensus result indicates that the cross-chain service block has passed the consensus, performing the step of pre-submitting the cross-chain service block to the first service branch chain, and storing the cross-chain service block in a first cross-chain storage space corresponding to the first service branch chain.

20. The computer device according to claim 15, wherein a main chain consensus node of the service main chain allocates an access permission to the second cross-chain storage space to the first consensus node of the first service branch chain, and allocates an access permission to the first cross-chain storage space to the second consensus node of the second service branch chain, and the method further comprises:
receiving a permission revocation indication information sent by the main chain consensus node, wherein the permission revocation indication information indicating that the main chain consensus node has revoked the access permission of the first consensus node to the second cross-chain storage space; and
the permission revocation indication information is generated by the main chain consensus node upon detecting that an access permission revocation condition is satisfied, and the access permission revocation condition comprises at least one of the following: the access permission time expiring, and relevant processing of the cross-chain service block being completed.
